(19) United States
(12) Patent Application Publication
(10) Pub. No.: US 2026/0163783 A1
(43) Pub. Date: Jun. 11, 2026

(54) Transmitter for Wireless Power and Broadband Data

(71) Applicant: NoiseFigure Research, Inc, Lubbock, TX (US)

(72) Inventors: Carlos Rangel-Ruiz, Renton, WA (US); Jerry Lopez, Renton, WA (US); Alexander William Boothby, Renton, WA (US)

(73) Assignee: NoiseFigure Research, Inc, Lubbock, TX (US)

(21) Appl. No.: 19/087,508

(22) Filed: Mar. 22, 2025

Related U.S. Application Data
(63) Continuation-in-part of application No. 18/907,906, filed on Oct. 7, 2024, now Pat. No. 12,284,064.

(51) Int. Cl. H04L 27/36; H04L 5/00; H04L 27/26

(52) U.S. Cl. CPC H04L 27/366; H04L 5/0014; H04L 27/2636; H04L 27/365

(57) ABSTRACT

A transmitter system comprises a mapper that maps data bits and power information to multiple subcarriers, producing mapped information. A first-level modulator receives a portion of this mapped information, converting it into subcarrier specifications defined by complex numbers. A first orthogonal subcarrier generator processes the specifications to generate baseband real and imaginary signals, encompassing part of the subcarriers. These signals are then modulated by a second-level modulator, which produces intermediate-frequency signals. A beamformer receives these signals, adjusting their phase and amplitude for one or more antenna channels to create directed intermediate-frequency signals. The system includes multiple antenna channel modules, each with a digital-to-analog converter that transforms the directed signals into analog form, driving antennas for transmission. This configuration enables efficient modulation and transmission of data across multiple subcarriers.

### REFERENCES

This application is a continuation-in-part of the following application, U.S. patent application serial no. 18/907,906, entitled "Systems and Methods for Directed Transmission and Reception of Wireless Power and Broadband Data", filed on October 7, 2024. All documents referred to in this patent application are hereby included by reference as if set forth in full.

### BACKGROUND

### TECHNICAL FIELD

The disclosed implementations relate generally to systems and methods used in wireless transmission and reception of power and data.

### CONTEXT

Wireless transmission of power has seen increased interest over the last decade. Data is transmitted in ever increasing bandwidths. Existing solutions for the simultaneous transmission of power and broadband data have suffered from interference of the data by the power.

### BRIEF DESCRIPTION OF THE DRAWINGS

The technology will be described with reference to the drawings, in which:

FIG. 1 illustrates an example system with a transmitter with spatial directivity and a receiver. The system is capable of wirelessly transferring broadband data and power from the transmitter to the receiver.

FIG. 2 illustrates an example double-sideband (DSB) spectrum that the transmitter may emit towards one or more receivers.

FIG. 3 illustrates an example single-sideband (SSB) radio spectrum that the transmitter may emit towards one or more receivers.

FIG. 4 illustrates an example architecture of the transmitter for directed transmission of power and broadband data. In this implementation, an orthogonal frequency-division multiplexed spectrum (an OFDM spectrum) may be quadrature modulated on an intermediate frequency by a second-level modulator, after which separate beams are formed for separate antenna channel modules each driving an antenna, for example a sub-antenna in a phased array antenna. An optional RF filter can remove a sideband to enable SSB transmission.

In FIG. 5, the architecture of FIG. 4 includes an SSB prep unit in the digital path to allow for efficient digital SSB removal. Using an SSB prep unit may enable more consistency and better power efficiency than using RF filters applied after the RF power amplifiers of individual antenna channel modules.

FIG. 6 illustrates an example architecture that can transmit data in one or more directions and power in a separate direction.

FIG. 7 illustrates an example architecture of transmitter 110 that can transmit data (and/or power) in a first direction and power (and/or static information) in a second direction.

FIGS. 8A-B illustrate two perspectives of an example architecture of the transmitter 110 in which beamforming is applied on the baseband signals, i.e., prior to second-level modulation. Mathematically and functionally, the two perspectives are identical.

FIG. 9 illustrates an example of direct-to-RF modulation in which beamforming is applied on the baseband signals, i.e., prior to second-level modulation. This implementation uses an RF backend 470 as described with reference to FIG. 21. Transmission can be made single sideband by applying RF filters in or after the antenna channel modules.

FIG. 10 illustrates another example of direct-to-RF modulation in which beamforming is applied on the baseband signals. This implementation uses an RF backend 470 as described with reference to FIG. 22. Transmission can be made single sideband by applying RF filters in or after the antenna channel modules.

FIG. 11 illustrates yet another example of direct-to-RF modulation in which beamforming is applied on the baseband signals. This implementation uses an RF backend 470 as described with reference to FIG. 21.

FIG. 12 illustrates an example implementation of second-level modulator 440. This second-level modulator provides DSB amplitude modulation for two independent input signals and produces two orthogonally modulated output signals.

FIG. 13 illustrates another example implementation of second-level modulator 440. This implementation may be used when the local digital logic clock speed is an even number times the IF.

FIG. 14 illustrates yet another example implementation of second-level modulator 440. It adds the output signals to a combined in-phase and quadrature modulated DSB IF signal. This implementation may be used when the local digital logic clock speed is four times the IF.

FIG. 15 illustrates an example second-level demodulator 442, for example as used in FIG. 11.

FIG. 16 illustrates an example implementation of SSB prep unit 450 based on Marple's method. This digital-domain circuit can take an input signal and produce orthogonal output signals with either negative or positive frequencies removed. Because of its digital nature and relative simplicity, it can remove a sideband even for very high-bandwidth signals. Marple's method can produce an ideal SSB filter with brick walls and linear phase.

FIG. 17 illustrates another example implementation of SSB prep unit 450, based on a Hilbert filter 1762.

FIG. 18 illustrates an example of beamformer 460.

FIG. 19 illustrates an example of phase rotator 461 that can be used as part of a beamformer 460 for a complex input signal, producing a complex output signal.

FIG. 20 illustrates another example of phase rotator 461 with a single output and based only on scaling the signal.

FIG. 21 illustrates an example unit of the radio frequency (RF) backend used to drive an antenna or a sub-antenna in the phased array antenna. Each sub-antenna requires one unit of the RF backend. The RF backend may include two DACs, each of which may be operated at twice the IF frequency used by the second-level modulator.

FIG. 22 illustrates another example of RF backend 470. that uses a single DAC. This implementation uses a single DAC, which may be operated at four times the IF frequency used by the second-level modulator.

FIG. 23 illustrates an example baseband and IF integrated circuit and an example antenna channel integrated circuit.

FIG. 24 illustrates an example method of transmitting data and power in one or more target directions. The method may use architectures such as proposed by FIGS. 4 and 5.

FIG. 25 illustrates an example method of transmitting data in a first direction and power in a second direction. The method uses an architecture such as proposed by FIG. 6.

In the figures, similar reference numbers may indicate functionally similar elements. The systems and methods illustrated in the figures—and described in the Detailed Description below—may be arranged and designed in a wide variety of different implementations. Neither the figures nor the Detailed Description are intended to limit the scope as claimed. Instead, they merely represent examples of different implementations.

### DETAILED DESCRIPTION

Researchers have developed and tested many systems for the wireless transfer of energy along with broadband data. Wireless transmission of digital data has been practiced for many decades, and data transfer bandwidths continue to increase with the availability of ever higher frequency bands in the radio spectrum. With the advent of 6G and 7G transmission systems, and radio spectra above 60 GHz, very high bandwidths may become available. For example data bits may have a bandwidth of more than one hundred megabits per second (100 Mbps) or even more than six gigabits per second (6 Gbps). The associated emitted signals may occupy a spectrum of at least ten megahertz (10 MHz) or two gigahertz (2 GHz), respectively. For the sake of efficiency, especially when a signal needs to transfer both data and energy, beamforming is important. However, systems developed so far have suffered from interference of the power with the data.

Implementations provide wireless transmission with spatial directivity of wideband data and one or more select-tone continuous waveforms (CWs) for wireless power charging (WPC). Some implementations use carriers with data, or static data, for WPC. Spatial directivity refers to the radiation of (data and/or) energy in a specific direction. An electronic system that can enable transmission or reception in a specific direction through beam steering is commonly known as a transmitter or receiver beamformer. Three types of beamformers are known in the art: analog, digital, and hybrid beamformers. They each have their advantages and disadvantages, but all can be used in the disclosed technology.

Beamforming may be achieved with a phased array antenna, i.e., an array of sub-antennas whose signals add up in some directions and cancel in other directions. Two sub-antennas cancel their signals in the direction of reception when, at the point of reception, those signals are of opposite polarity, that is, if their signals have opposite phase. Their signals reinforce each other if at the point of reception they have the same polarity, e.g., if their signals have the same phase. For example, in the direction of the line through the two sub-antennas, signals amplify each other if the distance between d the sub-antennas equals a whole integer N times a signal's wavelength λ, or d = N λ. The signals cancel each other if the distance d equals the half wavelengths in between, or d = (2N – 1) λ/2. Thus, the direction in which signals (partially or fully) amplify or cancel depends on the wavelength, i.e., on the signals' frequency, and the physical arrangement of the sub-antennas. Directivity may be rotated by changing a phase difference between the signals on the two sub-antennas. By using more than two sub-antennas, a phased array antenna can further increase directivity in the radiated pattern to increase a signal in the direction(s) needed and reduce it in other directions.

When there are multiple sub-antennas in the array, complicated patterns can be achieved, including patterns that resemble beams in certain directions. Beams can be dynamically created by phase shifting the signals being transmitted by the antennas or being received by the antennas. Phase shifting can be achieved by many different electronic circuits, including those that delay signals, and those that generate signals with a specific phase.

One technology to transmit many signals and/or power in a tight frequency spectrum, and thus with a high spectral efficiency, is orthogonal frequency division multiplexing (OFDM). OFDM uses multiple subcarriers spaced at equal frequency distances and sends data symbols at least for a duration with which the frequency distance becomes orthogonal. For example, for a one-second symbol duration, subcarriers can be spaced at 1 Hz intervals. For a 3.2 microseconds OFDM symbol duration, subcarriers can be spaced at 312.5 kHz intervals, etc. Information is encoded in the relative amplitude and phase of each subcarrier. While OFDM can provide excellent protection against interference because the subcarriers are orthogonal to each other, beamforming can be complex if the OFDM system has many subcarriers and the phased array antenna has many sub-antennas. Beamforming with conventional linear-phase filters may be inaccurate and may be difficult to change dynamically.

The technology disclosed herein uses a first level of modulation with OFDM (or similar technology that employs multiple subcarriers that are orthogonal to each other) to simultaneously transmit data and power, and a second level double-sideband (DSB) or single-sideband (SSB) amplitude modulation to allow beamforming with a phased array antenna to simultaneously transmit the data and/or power to multiple clients. The first modulation level preserves orthogonality, which eliminates or greatly reduces interference between the transmitted power and data, and the second modulation level, which uses a single carrier frequency, allows for efficient beamforming.

### TERMINOLOGY

As used herein, the phrase "one of" should be interpreted to mean exactly one of the listed items. For example, the phrase "one of A, B, and C" should be interpreted to mean any of: only A, only B, or only C.

As used herein, the phrases at least one of and one or more of should be interpreted to mean one or more items. For example, the phrase "at least one of A, B, or C" or the phrase "one or more of A, B, or C" should be interpreted to mean any combination of A, B, and/or C. The phrase "at least one of A, B, and C" means at least one of A and at least one of B and at least one of C.

Unless otherwise specified, the use of ordinal adjectives first, second, third, etc., to describe an object merely refers to different instances or classes of the object and does not imply any ranking or sequence.

The terms "comprising" and "consisting" have different meanings in this patent document. An apparatus, method, or product "comprising" (or "including") certain features means that it includes those features but does not exclude the presence of other features. On the other hand, if the apparatus, method, or product "consists of" certain features, the presence of any additional features is excluded.

The term "coupled" is used in an operational sense and is not limited to a direct or an indirect coupling. "Coupled to" is generally used in the sense of directly coupled, whereas "coupled with" is generally used in the sense of directly or indirectly coupled. Coupled in an electronic system may refer to a configuration that allows a flow of information, signals, data, or physical quantities such as electrons between two elements coupled to or coupled with each other. In some cases, the flow may be unidirectional, in other cases the flow may be bidirectional or multidirectional. Coupling may be galvanic (in this context meaning that a direct electrical connection exists), capacitive, inductive, electromagnetic, optical, or through any other process allowed by physics.

The term "connected" is used to indicate a direct connection, such as electrical, optical, electromagnetic, or mechanical, between the things that are connected, without any intervening things or devices.

The term "configured" to perform a task or tasks is a broad recitation of structure generally meaning having circuitry that performs the task or tasks during operation. As such, the described item can be configured to perform the task even when the unit/circuit/component is not currently on or active. In general, the circuitry that forms the structure corresponding to configured to may include hardware circuits, and may further be controlled by switches, fuses, bond wires, metal masks, firmware, and/or software. Similarly, various items may be described as performing a task or tasks, for convenience in the description. Such descriptions should be interpreted as including the phrase configured to.

As used herein, the term "based on" is used to describe one or more factors that affect a determination. This term does not foreclose the possibility that additional factors may affect the determination. That is, a determination may be solely based on specified factors or based on the specified factors as well as other, unspecified factors. Consider the phrase "determine A based on B". This phrase specifies that B is a factor that is used to determine A or that affects the determination of A. This phrase does not foreclose that the determination of A may also be based on some other factor, such as C. This phrase is also intended to cover an implementation in which A is determined based solely on B. The phrase based on is thus synonymous with the phrase based at least in part on.

The terms "substantially", "close", "approximately", "near", and "about" refer to being within minus or plus 10% of an indicated value, unless explicitly specified otherwise.

The following terms or acronyms used herein are defined at least in part as follows:

"ASIC" - application-specific integrated circuit

"BB" - baseband

"CGRA" - coarse-grained reconfigurable architecture

"CMOS transistor" – complementary metal-oxide-semiconductor transistor

"DAC" – digital-to-analog converter

"DCT" – discrete cosine transform

"DFT" – discrete Fourier transform

"DSB" – double sideband

"FET" – field-effect transistor

"FFT" – fast Fourier transform

"FPGA" - field-programmable gate array

"GAAFET" – gate all-around FET

"HBT" – heterojunction bipolar transistor

"IC" – integrated circuit – a monolithically integrated circuit, i.e., a single semiconductor die which may be delivered as a bare die or as a packaged circuit. For the purposes of this document, the term integrated circuit also includes packaged circuits that include multiple semiconductor dies, stacked dies, or multiple-die substrates. Such constructions are now common in the industry, produced by the same supply chains, and for the average user often indistinguishable from monolithic circuits.

"IDCT" – inverse discrete cosine transform

"IDFT" – inverse discrete Fourier transform

"IFFT" – inverse fast Fourier transform

"IF" – intermediate frequency

"IFFT" – inverse fast Fourier transform

"JFET" – junction FET

"LDPC" – low-density parity check

"Marple's method" – a method of removing negative frequency components from a signal, as described in "Computing the discrete-time 'analytic' signal via FFT," by S.L. Marple Jr, IEEE Transactions on Signal Processing, Volume 47, September 1999.

"MCM" – multi-chip module

"MESFET" – metal–semiconductor field-effect transistor

"Metadata" – data about other data, about a configuration, about a transmission, or containing identifying information

"MOS transistor" – metal-oxide-semiconductor transistor

"NMOS transistor" – n-type MOS transistor

"OFDM" – orthogonal frequency division multiplexing. A technology that modulates data on multiple closely spaced subcarriers that are orthogonal to each other.

"PAM" – pulse amplitude modulation

"PCB" – printed circuit board

"Phased array antenna" – for the purposes of this patent document, a phased array antenna is any collection of sub-antennas transmitting or receiving signals that are phase-related to each other. In some cases, the sub-antennas are arranged in a regular array in one, two, or three dimensions.

"PMOS transistor" – p-type MOS transistor

"QAM" – quadrature amplitude modulation

"QPSK" – quad phase shift keying

"RF" – radio frequency

"SSB" – single sideband

### IMPLEMENTATIONS

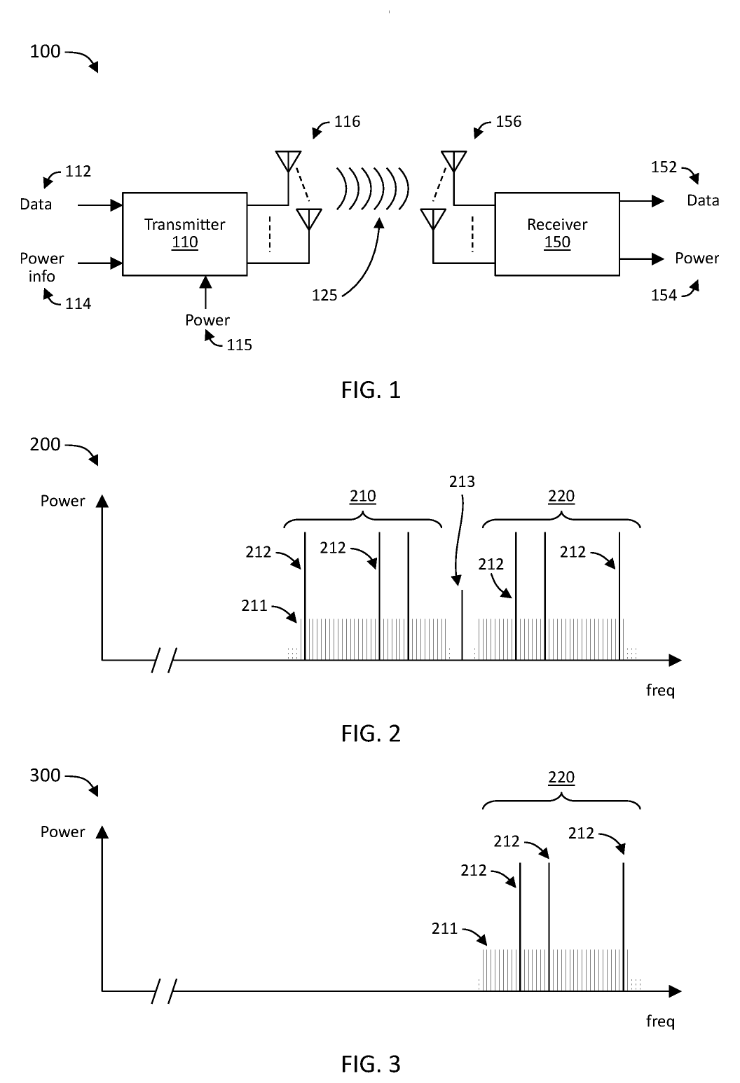

FIG. 1 illustrates an example system 100 with a transmitter 110 with spatial directivity and a receiver 150. The system is capable of wirelessly transferring broadband data 112 and at least a part of power 115 from the transmitter 110 to the receiver 150. Transmitter 110 receives data 112 and power information 114. It processes the data 112 to be transmitted and the power information 114 that specifies how power 115 is to be transmitted via, for example, phased array antenna 116 and electromagnetic beam 125 to receiver 150. Receiver 150, which may also have a phased array antenna, receives electromagnetic beam 125, decodes its signals and harvests (at least a part of) its power, to recreate recovered data 152 and deliver harvested power 154. In a robust implementation and under adequate transmission and reception conditions, recovered data 152 equals data 112 close to 100% of the time and harvested power 154 is a reasonable portion of power 115. Adequate transmission and reception conditions may include a line-of-sight between phased array antenna 116 and phased array antenna 156, sufficiently favorable atmospheric conditions, and a distance between phased array antenna 116 and phased array antenna 156 that allows harvesting a sufficient part of the transmitted power 115 and high-quality recovery of the transmitted data 112.

FIG. 2 illustrates an example double-sideband (DSB) spectrum 200 that the transmitter may emit towards one or more units of receiver 150. Spectrum 200 includes a lower sideband 210 and an upper sideband 220 located around a radio frequency carrier (RF carrier 213). Both lower sideband 210 and upper sideband 220 include up to N subcarriers, including data subcarriers 211 and one or more power subcarriers 212, where N is greater than 1. Upper sideband 220 carries an OFDM (or similar) spectrum with all encoded information, and lower sideband 210 carries the same OFDM (or similar) spectrum, mirrored versus RF carrier 213. An implementation may suppress RF carrier 213, for example when it does not use RF carrier 213 for the transmission of power. In some implementations, power subcarriers 212 may have a constant (relatively high) amplitude, i.e., they are select-tone continuous waveforms, whereas data subcarriers 211 may have a relatively low average amplitude, and a temporary amplitude that depends on the data being transmitted. In other implementations, power subcarriers 212 may have any amplitude, for example based on the needs of an individual recipient or group of recipients. In yet other applications, a power subcarrier 212 may be modulated with data and/or metadata. In typical OFDM systems, data carriers have a flat spectrum, because data is randomized to reduce channel disturbances and to provide encryption. Another factor adding to the spectrum's flatness is the removal, as much as possible, of redundancy in the data itself. However, OFDM systems may add redundancy to combat channel noise, and to enable detection and correction of transmission errors.

An implementation may generate the OFDM (or similar) spectrum in various ways. A digital implementation may specify the phase and amplitude (or real and imaginary components) of each subcarrier and use an inverse discrete Fourier transform (IDFT) or an inverse fast Fourier transform (IFFT) to translate signals from the frequency domain to the time domain and calculate a real and an imaginary time series with the baseband (BB) version of the spectrum of upper sideband 220. An analog implementation may use a reference frequency as an input to a bank of phase locked loops, each of which creates one of the subcarriers. With current technologies, digital implementations are far less costly and have the advantage that they can be designed to any required mathematical precision. An implementation may use any transform that can generate a signal in the time domain based on a definition in the frequency or similar domain, and vice versa. Examples include the Fourier transform, DFT/IDFT, FFT/IFFT, discrete cosine transform (DCT/IDCT), Laplace transform, wavelet transform, and any other orthogonal frequency-time transform. Because of its present low cost of manufacture and use, examples in this document may show FFT and IFFT implementations, even though other implementations are possible.

DSB amplitude modulation (AM) radio has been demonstrated as early as 1899 (see https://en.wikipedia.org/wiki/Amplitude_modulation and U.S. patent no. 775,337, "Wireless Telephone," Roberto Landell de Moura, filed October 4, 1901, issued November 22, 1904) and is still practiced today. However, a disadvantage of DSB AM transmission is its low spectral efficiency, which is never above 50%. This disadvantage was known and understood a long time ago, leading to the development of single-sideband (SSB) radio systems (U.S. patent 1,449,382 John Carson/AT&T, "Method and Means for Signaling with High Frequency Waves" filed on December 1, 1915; granted on March 27, 1923).

FIG. 3 illustrates an example SSB spectrum 300 that the transmitter may emit towards one or more units of receiver 150. This example shows upper sideband 220, whereas lower sideband 210 has been suppressed, along with RF carrier 213. In a typical implementation, most of the subcarriers are used for data, and one or more subcarriers are used for power. Some other carriers may be used as pilot subcarriers to help receiver 150 achieve time and frequency synchronization, and further subcarriers may be used for transmission of metadata. On the outsides of each sideband may be a number of guard subcarriers (here drawn as short dotted lines). These are unused subcarriers with zero (or close to zero) amplitude, which help guard against adjacent channel interference. For example, a WiFi IEEE 802.11a OFDM symbol may have 64 subcarriers, including 48 for data, 4 for pilots, and 12 guard subcarriers, most of which are at the outsides of the sidebands. The symbol may have a duration of 3.2 µs, to which a cyclic guard interval of 0.8 µs is prepended to guard against multipath (i.e., inter-symbol) interference.

For an N-point IFFT, spectrum 300 can include up to N subcarriers, including data subcarriers 211 and one or more power subcarriers 212. This example shows a first, second, and third power subcarrier, but other implementations may have any other number of power subcarriers 212. Power subcarriers 212 may have a different amplitude than data subcarriers 211, for example a higher amplitude. Although in FIG. 3 all power subcarriers are drawn with the same amplitude, in some implementations the amplitude of the power subcarriers varies. For example, the amplitude of a power subcarrier for a nearby recipient may be smaller than the amplitude of the power carrier for a faraway client. Spectrum 300 may also include pilot carriers (not separately drawn), which may be at a different amplitude (for example, lower) than data subcarriers 211. An implementation may not use all available subcarriers. For example, to reduce interference with other signals in adjacent frequency bands, an implementation may not use some of the outer subcarriers.

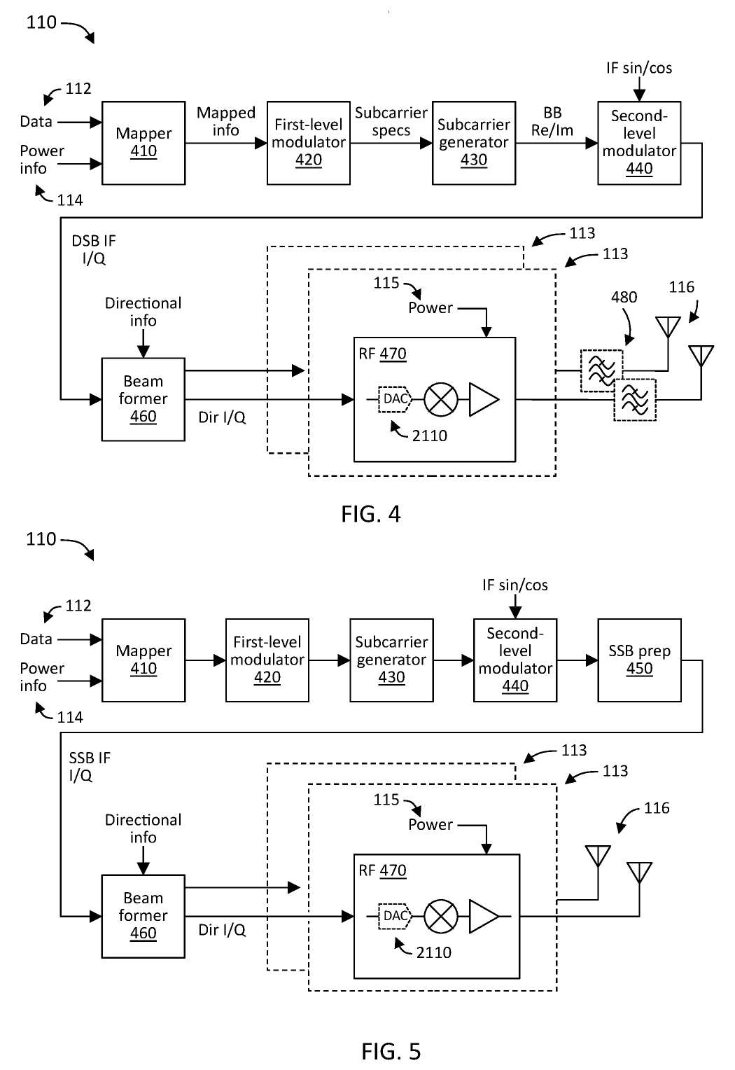

FIG. 4 illustrates an example architecture of transmitter 110 for directed transmission of power and broadband data. In this implementation, an OFDM spectrum or similar may be quadrature modulated on an intermediate frequency by a second-level modulator 440, after which separate beams are formed for separate antenna channel modules each driving an antenna 116, for example a sub-antenna in a phased array antenna. Transmitter 110 receives data 112 (and may separate data 112 in data blocks called frames, each frame to be transmitted during one OFDM symbol) and power information 114. Data 112 may have been compressed for efficiency and encrypted for security. It may include separate messages or streams for separate destinations, each of which may have an individual receiver 150. DSB transmission simplifies the architecture needed for transmission and the architecture needed for reception of the data. Whereas DSB transmission uses twice the bandwidth of SSB transmission for the same amount of data, in some applications this may be acceptable. An optional RF filter 480 can remove a sideband to enable SSB transmission.

Data 112 and power information 114 enter mapper 410, whose function is to map data bits in data 112 and metadata in power information 114 to up to N individual subcarriers in the multi-carrier frequency spectrum to be transmitted. Mapper 410 may further define the function and appearance of subcarriers for other uses, such as a pilot subcarrier, and guard subcarriers. Mapper 410 may also perform other functions such as adding redundancy to the data to allow for error detection and correction, interleaving data bits over non-adjacent subcarriers to combat fixed-frequency interferences, redistributing data bits over time to combat burst interferences such as may be caused by lighting, and convolutional coding or LDPC coding to ease demodulation. Mapper 410 outputs mapped information, i.e. information for every subcarrier for the duration of the OFDM symbol. The mapped information may include the required amplitude and phase of power subcarriers 212 and pilot subcarriers, the data bits to be included in data subcarriers 211, and which of the subcarriers are designated as guard subcarriers. Mapper 410 may work in a customized way, or according to a standardized communications protocol, such as IEEE802.11 or any other protocol.

The first-level modulator 420 receives the mapped information and converts the mapped information to subcarrier specifications. The subcarrier specifications may include complex numbers that each define a real and an imaginary component of a subcarrier. For data subcarriers 211, the subcarrier specification is based on the data bits to be transmitted and on the implemented and/or selected modulation scheme, which may be any modulation scheme known in the art, including binary phase shift keying (BPSK), quadrature phase shift keying (QPSK), M-ary phase shift keying (M-ary PSK), quadrature amplitude modulation (QAM, e.g., QAM16, QAM64, QAM256, etc.), pulse-amplitude modulation (PAM), etc.

First-level modulator 420 works in tandem with orthogonal subcarrier generator 430, which receives the subcarrier specifications, and generates and sums the subcarriers resulting in a baseband real signal (the BB Re signal) and a baseband imaginary signal (the BB Im signal). Orthogonal subcarrier generator 430 outputs these as waveforms (if analog) or as a time-domain series of N successive Re and Im values (if digital) that includes the up to N subcarriers. Orthogonal subcarrier generator 430 may implement an inverse Fourier transform, an N-point IDFT, an N-point IFFT, an N-point IDCT, or any other orthogonal frequency-to-time (or similar) transform.

The second-level modulator 440 multiplies the BB Re signal with a sine wave of an intermediate frequency (IF) and the BB Im signal with a cosine wave of the intermediate frequency. The multiplications result in amplitude modulation of the BB Re signal into a (DSB) IF I signal and of the BB Im signal into a (DSB) IF Q signal. Thus, second-level modulator 440 modulates the multiple subcarriers onto the real and imaginary components of a single IF carrier.

For example, 63 of the 64 subcarriers of an IEEE 802.11a signal are defined as located symmetrically around the zero frequency at a spacing of 0.3125 MHz between -10 MHz and +10 MHz. However, the subcarriers are not modulated symmetrically, so that a 64-point IFFT outputs both 64 real time samples (the BB Re signal) and 64 imaginary time samples (the BB Im signal). Amplitude modulation of the BB Re signal and the BB Im signal, for example with a 25 MHz IF signal in second-level modulator 440, translates the subcarriers to a band from15 to 35 MHz. Technically, this is a double sideband signal, but the sidebands do not contain the same information because the subcarriers are modulated asymmetrically. However, the amplitude modulation also results in frequency components in the band from -15 to -35 MHz. These components are symmetrical to the frequency components in the band from +15 to +35 MHz.

Beamformer 460 receives the IF I signal and the IF Q signal, and directional information for each of M sub-antennas in phased array antenna 116, and modifies the phase and amplitude of the IF I signal and the IF Q signal for the up to M channels that feed phased array antenna 116. It may do so, for example, by multiplying the IF I signal and the IF Q signal with a first complex number for the first channel, with a second complex number for the second channel, with a third complex number for the third channel, and so on. Thus, beamformer 460 outputs M directed IF I/Q signals, i.e., the results of the up to M complex multiplications of the IF I and Q signals with the M separate complex numbers for the M channels of phased array antenna 116, where the M separate complex numbers define the directivity of phased array antenna 116 for the final RF transmission frequency. However, at this stage the signals are still at the intermediate frequency. M units of RF backend 470 take the M directed IF I and Q signals, upconvert them to the final RF transmission frequency, combine them into M directed complex RF signals, and provide power amplification to power the M sub-antennas in phased array antenna 116. The signal is a DSB signal, but it may be prepared for single-sideband transmission, for example using RF filters 480, or as described with reference to FIG. 5.

FIG. 5 illustrates an example architecture of transmitter 110 for single sideband (SSB) directed transmission of power and broadband data. In FIG. 5, the implementation of FIG. 4 further includes an SSB prep unit 450 in the digital path to allow for efficient digital SSB removal. Using an SSB prep unit may enable more consistency and better power efficiency than using RF filters 480 applied after the RF power amplifiers of individual antenna channel modules 113. SSB prep unit 450 is located between second-level modulator 440 and beamformer 460. SSB prep unit 450 is configured to prepare the IF I/Q signal for RF frequency translation resulting in an SSB signal, for example by the techniques described with reference to FIGS. 16-17, or by any other technique known in the art.

In some implementations, the first SSB prep unit 450 is implemented in an integrated circuit (IC) using dedicated logic and/or a digital signal processor (DSP).

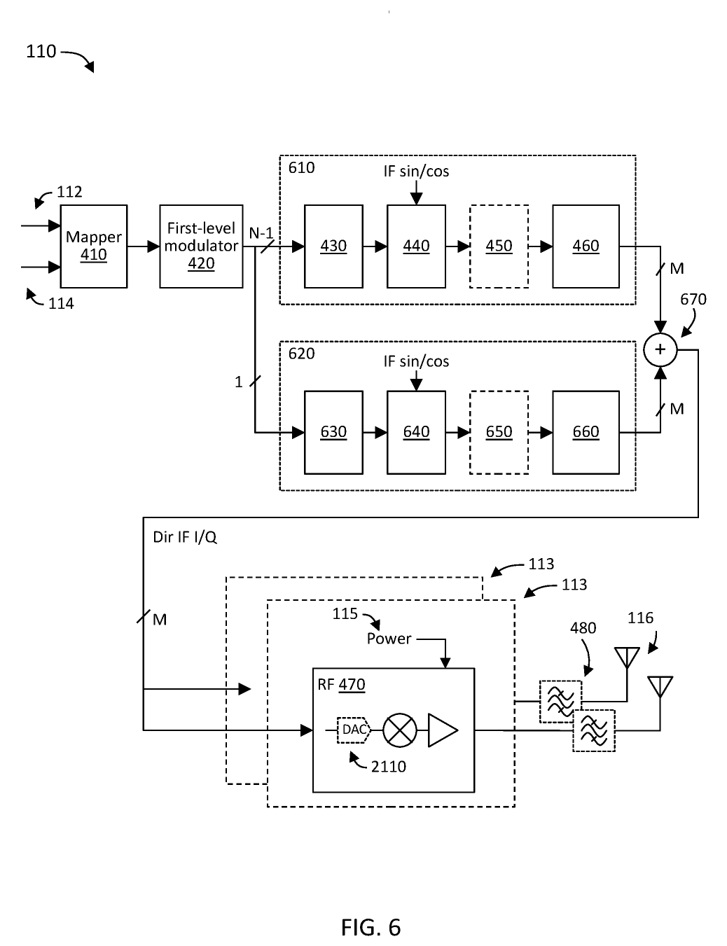

FIG. 6 illustrates an example architecture of transmitter 110 that can transmit data (and/or power) in one or more directions and power (and/or data) in a separate direction. The architecture includes the functional blocks described with reference to FIGS. 4-5 but can create and direct multiple independent beams since it uses multiple beamformers. A first part of the subcarrier specifications from first-level modulator 420 enters a first path 610 and a second part of the subcarrier specifications enters a second path 620. For example, the first part of the subcarrier specifications may cover N-1 subcarriers to transmit with a first directional pattern, and the second part of the subcarrier specifications may cover one subcarrier to transmit with a second directional pattern. First path 610 includes orthogonal subcarrier generator 430, second-level modulator 440, optionally SSB prep unit 450, and beamformer 460. The second path 620 duplicates orthogonal subcarrier generator 430 in orthogonal subcarrier generator 630, second-level modulator 440 in second-level modulator 640, optional SSB prep unit 450 in optional SSB prep unit 650, and beamformer 460 in beamformer 660. Beamformer 460 delivers M directed IF signals that include the first part of the subcarriers, and beamformer 660 delivers M directed IF signals that include the second part of the subcarriers.

A combiner 670 adds the M signals from beamformer 460 to the M signals from beamformer 660 resulting in M directed IF I/Q signals for the M units of RF backend 470. Depending on whether an implementation includes SSB prep unit 450 and SSB prep unit 650, these signals may include single or double sidebands. By separating the second part of the subcarrier specifications from the first part of the subcarrier specifications, the implementation can direct the second part of the subcarriers totally independent of the first part of the subcarriers. This can be advantageous in situations where, for example, power needs to be directed independently from the data streams. It also provides the possibility of steering power in a much narrower direction than the data streams. It further provides the possibility to scale the power in, for example, second path 620 to a larger value without requiring an increased resolution of the circuits in first path 610, provided that the M units of RF backend 470 can handle the required larger dynamic range.

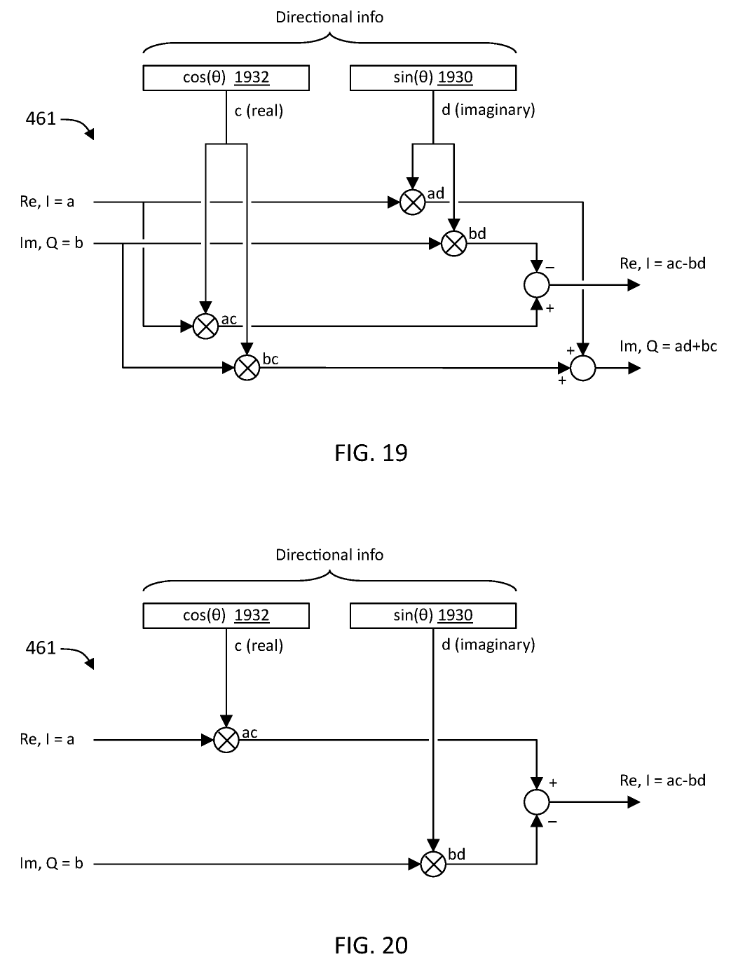

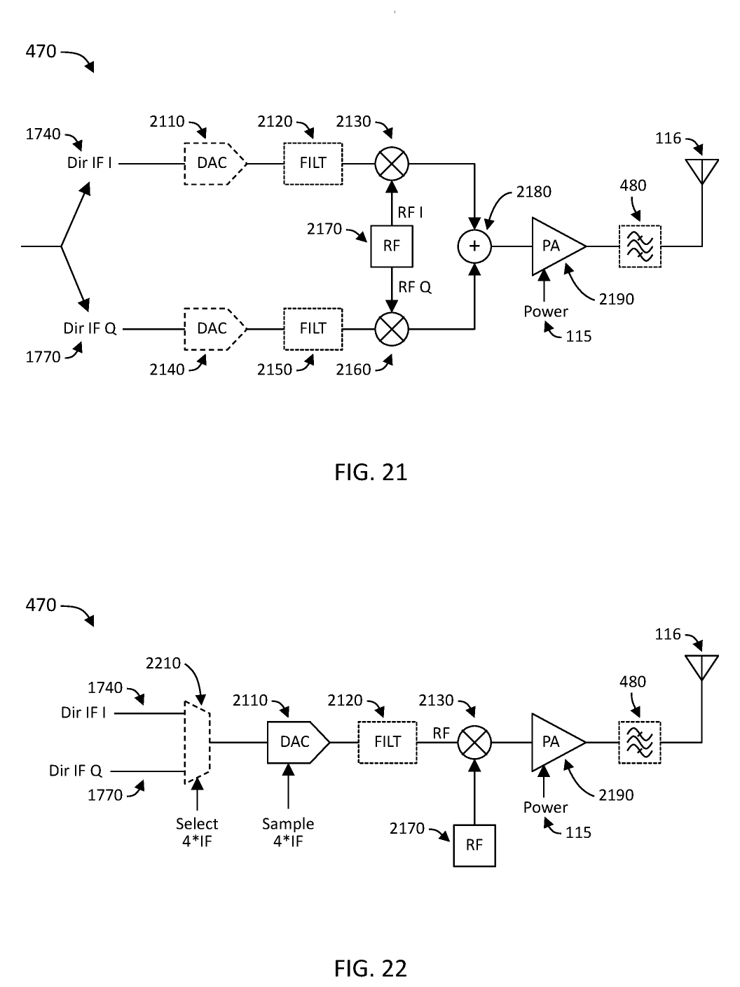

Some implementations combine electronic circuits of first path 610 and second path 620, for example by time-multiplexing their input and output signals and using the electronic circuits at double speed. Some implementations have beamformers 460 with phase rotators 461 as depicted in FIG. 19, others as depicted in FIG. 20. Some implementations use RF backend 470 as depicted in FIG. 21, others as depicted in FIG. 22.

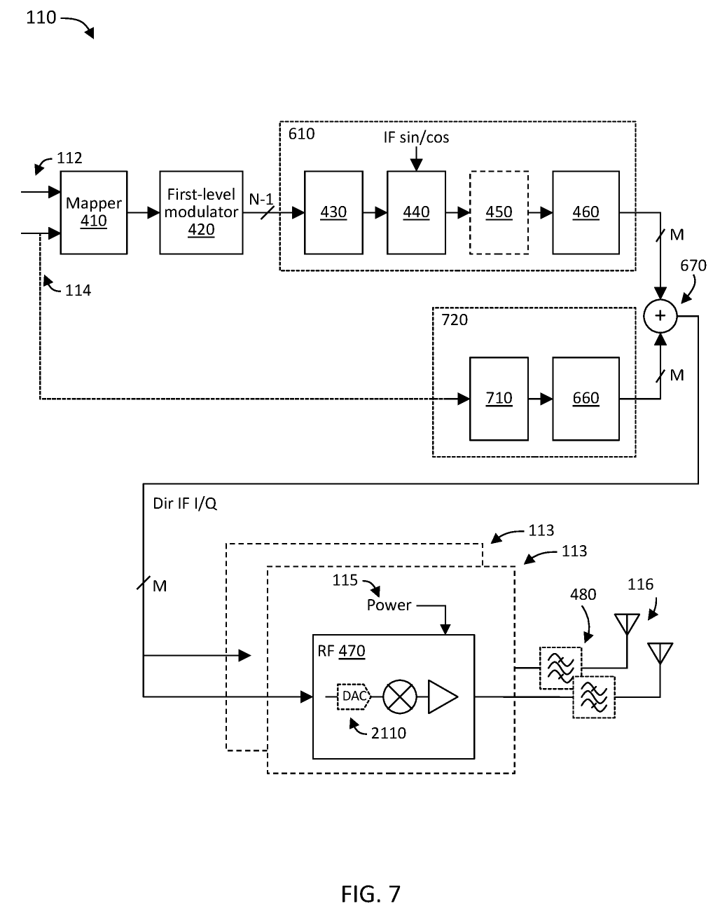

FIG. 7 illustrates an example architecture of transmitter 110 that can transmit data (and/or power) in a first direction and power (and/or static information) in a second direction. The architecture is similar to the architecture in FIG. 6, and blocks they have in common share the functionality described with reference to FIGS. 4-6. However, instead of second path 620, FIG. 7 has second path 720 that includes a memory 710 and beamformer 660. Power subcarriers, and other subcarriers that have the same information or content from OFDM frame to OFDM frame, don't need to be reconstructed for every OFDM frame. Instead, they can be calculated or generated once and stored in memory 710. The memory can be read once per frame, its content serving as input data for beamformer 660. Thus, the content of memory 710 may equal the output data that second-level modulator 640 or SSB prep unit 650 in FIG. 6 would have produced. Memory 710 may be a read-only memory (ROM), a non-volatile memory (NVM), a serial or cyclical memory, or a random-access memory (RAM). Its content may be hardwired (ROM), preconfigured (NVM), entered from an external source via power information 114, or generated by first path 610, for example during a system startup cycle prior to transmission.

Although the implementations in FIGS. 6-7 show two paths (first path 610 and second path 620 or second path 720), other implementations may include any number of paths. Thus, regardless of the number of antennas and antenna channel modules 113, a phased array antenna 116 can transmit any number of beams.

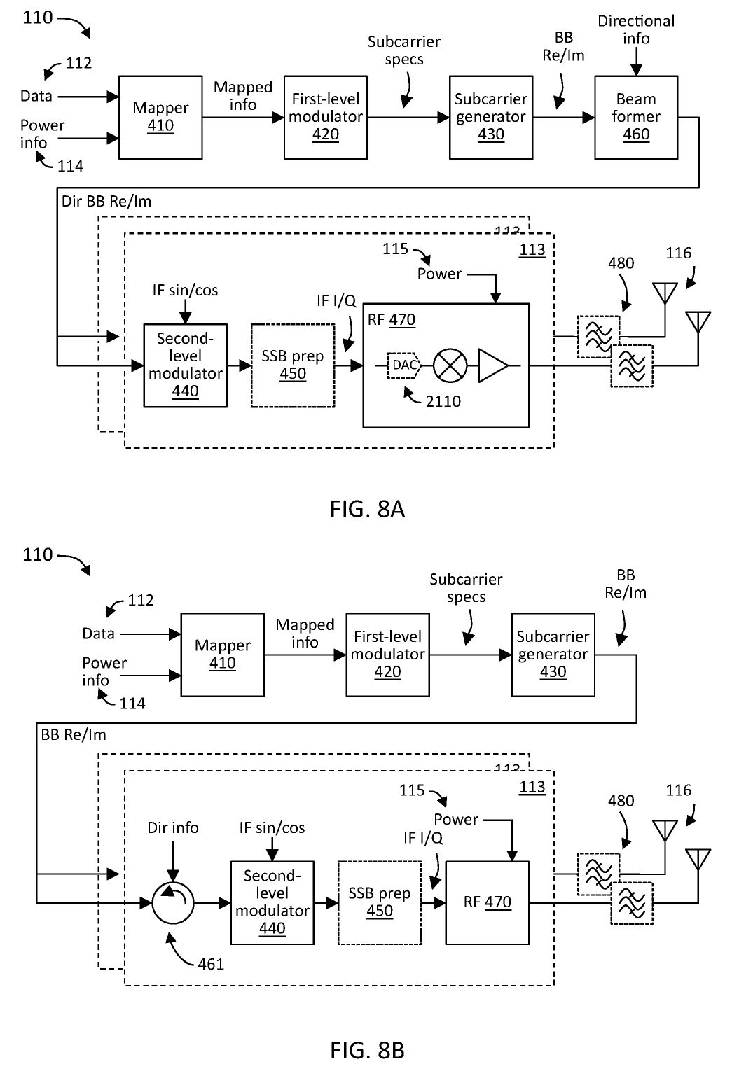

FIGS. 8A-B illustrate two perspectives of an example architecture of the transmitter 110 in which beamforming is applied on the baseband signals, i.e., prior to second-level modulation.

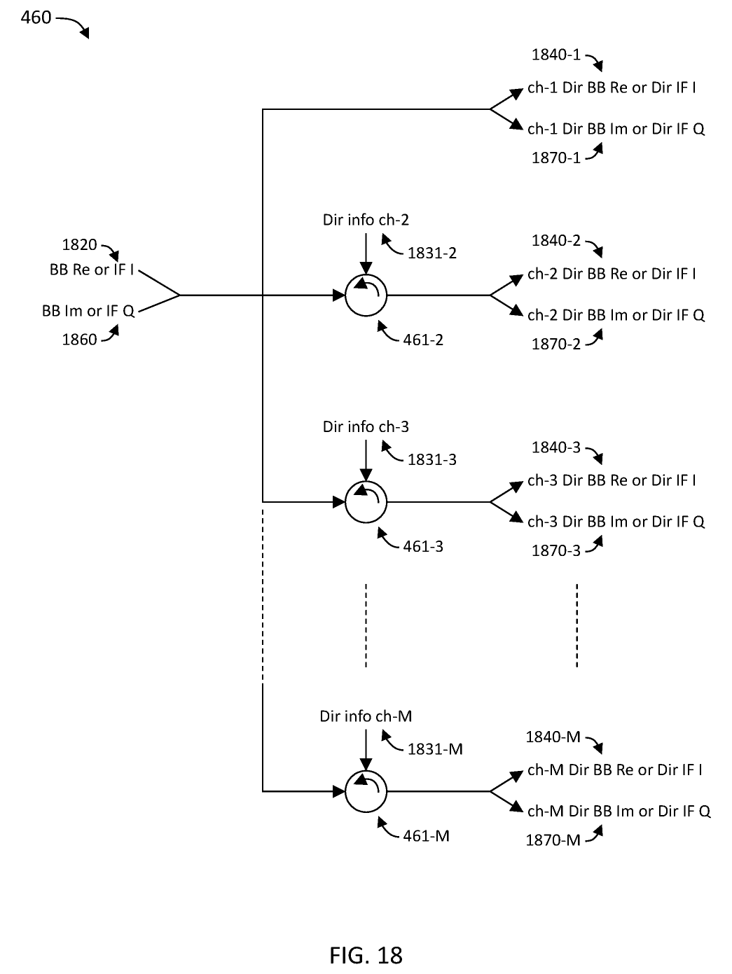

Mathematically, the result of rotating a complex signal (BB Re) + i (BB Im) over an angle θ and using the result to quadrature modulate an IF is the same as quadrature modulating the complex signal on the IF and then rotating the IF over the angle θ. Thus, implementations can swap beamforming and second-level modulation as convenient. However, since beamformer 460 has one phase rotator 461 for each antenna channel module 113 (see FIG. 18), this means that if beamforming is performed prior to second-level modulation, there must be one second-level modulator 440 for each antenna channel module 113. Thus, FIGS. 8A and 8B are mathematically equivalent to FIGS. 4-5. FIG. 8A depicts beamformer 460 as a single unit in the path shared between the antenna channel modules 113. FIG. 8B takes the perspective that each phase rotator 461 is included in an antenna channel module 113, as shown in FIG. 18. Thus, FIGS. 8A and 8B are also equivalent to each other.

To transmit only a single sideband, there are two options. Transmission can be made single sideband by applying SSB prep units 450 and/or RF filters 480. Using SSB prep unit 450 has the advantage that, since it is a digital circuit, its effect on each antenna signal is identical. Although RF filter 480 may be manufactured with tight specifications, it is an analog circuit and manufacturing variations may introduce slight differences in transfer function. An implementation may include RF filters 480 between antenna channel modules 113 and phased array antenna 116. Alternatively, an implementation may include RF filter 480 inside an antenna channel module 113, for example before the RF power amplifier.

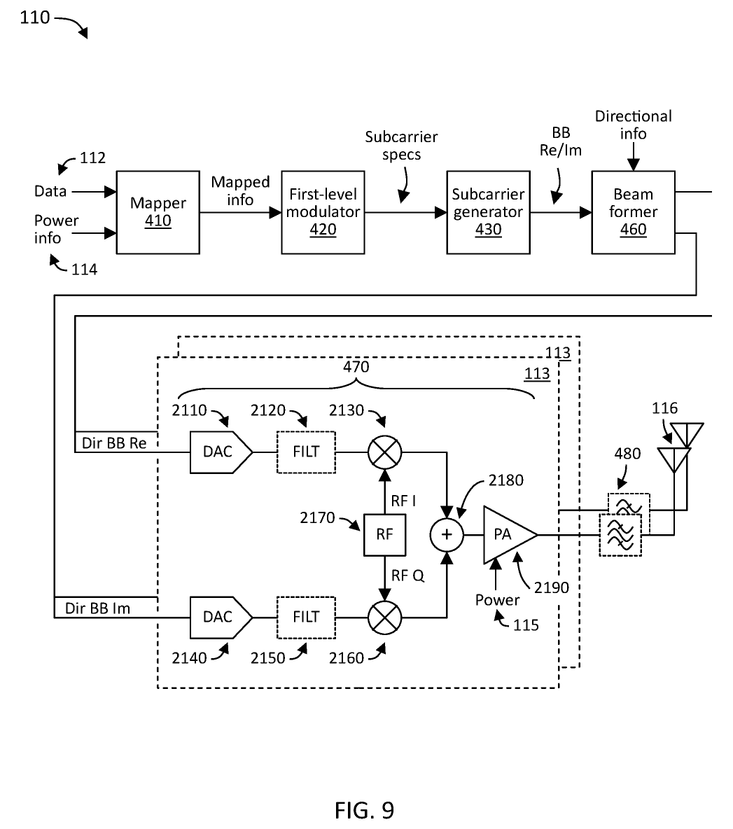

FIG. 9 illustrates an example of direct-to-RF modulation in which beamforming is applied on the baseband signals. Transmitter 110 receives data 112 and power information 114 and generates subcarrier specifications based on the data 112 and power information 114, as described with reference to FIG. 4 and elsewhere. Beamformer 460 rotates, for each antenna channel module 113, the series of complex values produced by orthogonal subcarrier generator 430. The directed real and imaginary baseband values (Dir BB Re and Dir BB Im) enter an antenna channel module 113, where DAC 2110 and DAC 2140 convert them from digital to analog signals. Some implementations may include filter 2120 and filter 2150 to remove high-frequency components from the analog directed baseband values. In these implementations, an antenna channel module 113 may include, for example, an RF backend 470 as described with reference to FIG. 21. The rotated (i.e., directed) baseband values directly determine the phase and amplitude of the RF signal at the output of adder 2180. RF power amplifier 2190 amplifies the data and provides at least a part of power 115 as specified by power information 114.

To transmit only a single sideband, an implementation may apply RF filters 480 between antenna channel modules 113 and phased array antenna 116. Alternatively, an implementation may include RF filter 480 inside an antenna channel module 113, for example before the RF power amplifier 2190.

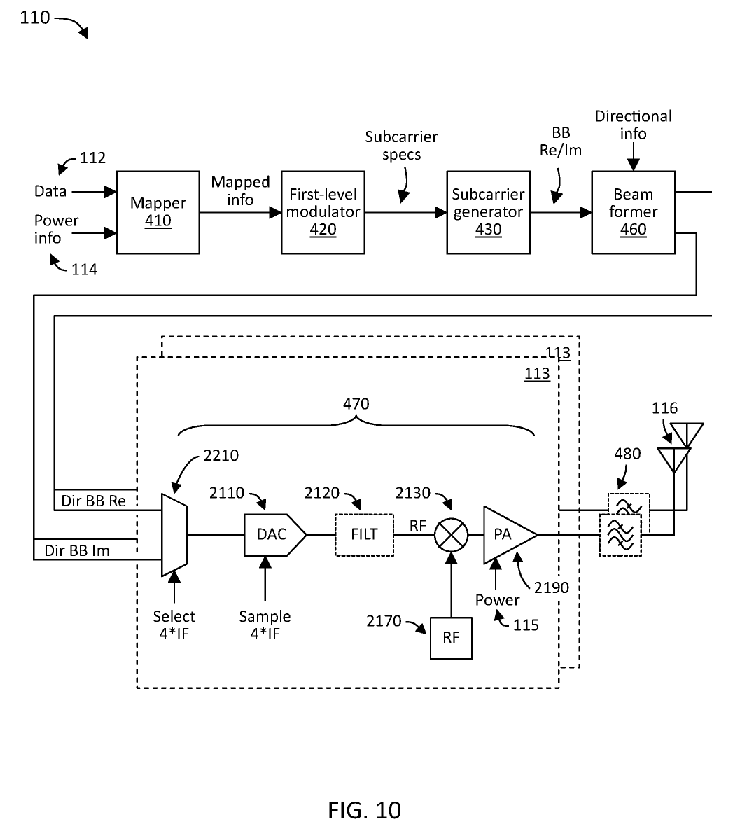

FIG. 10 illustrates another example of direct-to-RF modulation in which beamforming is applied on the baseband signals. Transmitter 110 receives data 112 and power information 114 and generates subcarrier specifications based on the data 112 and power information 114, as described with reference to FIG. 4 and elsewhere. Beamformer 460 rotates, for each antenna channel module 113, the series of complex values produced by orthogonal subcarrier generator 430. The directed real and imaginary baseband values (Dir BB Re and Dir BB Im) enter the antenna channel modules 113. This implementation may use an RF backend 470 as described with reference to FIG. 22.

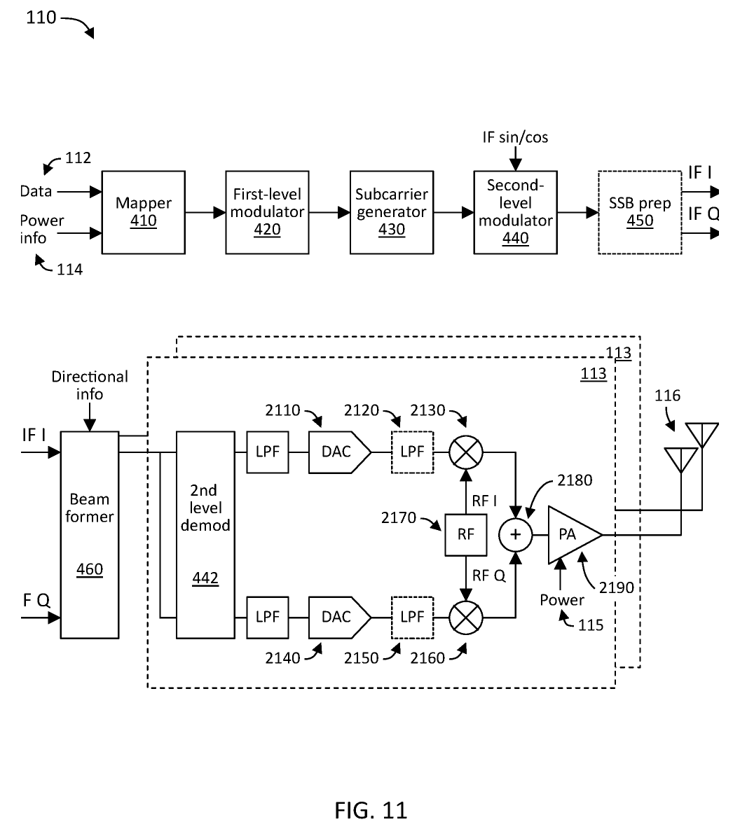

FIG. 11 illustrates yet another example of direct-to-RF modulation. In this implementation, the shared digital path includes a second-level modulator 440, an optional SSB prep unit 450 and a beamformer 460. Individual antenna channel modules 113 may include a second-level demodulator 442 and one or two DACs. In implementations according to FIG. 11, a direct-to-RF transmitter 110 includes:

Mapper 410 configured to map data bits 112 and power information 114 to N subcarriers. Mapper 410 produces mapped information, and N is an integer larger than 1.

First-level modulator 420 is coupled with an output of the mapper 410 and configured to receive at least a first part of the mapped information and convert this into subcarrier specifications. A subcarrier specification may include a complex number that defines an amplitude and a phase of a subcarrier.

The first orthogonal subcarrier generator 430 is coupled with an output of the first-level modulator 420 and configured to receive the subcarrier specifications, to generate the baseband real signal (the BB Re signal), and to generate the baseband imaginary signal (the BB Im signal). The BB Re signal and the BB Im signal include the N subcarriers.

The first second-level modulator 440 is coupled with an output of the first orthogonal subcarrier generator 430 and configured to receive the BB Re signal and the BB Im signal. It multiplies the BB Re signal with the IF sine wave and multiplies the BB Im signal with the IF cosine wave. It generates the IF I signal and the IF Q signal.

The first beamformer 460 is (directly or indirectly) coupled with an output of first second-level modulator 440 and configured to receive the IF I signal and the IF Q signal. For one or more antenna channels, it modifies the phase and/or amplitude of the IF I signal and/or the IF Q signal and generates a directed IF I signal and/or a directed IF Q signal.

Two or more antenna channel modules 113 are configured to drive an antenna 116 and include:

A second-level demodulator 442 with two inputs both coupled with a single output of the first beamformer 460 Second-level demodulator 442 is configured to receive either the directed IF I signal or the directed IF Q signal and to demodulate this into a directed BB Re signal and a directed BB Im signal.

A first DAC 2110 coupled with an output of the second-level demodulator 442 and configured to convert the directed BB Re signal to an analog Re signal.

A second DAC 2140 coupled with an output of the second-level demodulator 442 and configured to convert the directed BB Im signal to an analog Im signal.

A central oscillator 2170 coupled with the first DAC 2110 producing an RF I signal and an RF Q signal. A first mixer 2130 is coupled with the first DAC 2110 and the central oscillator 2170. A second mixer 2160 is coupled with the second DAC 2140 and the central oscillator 2170. An adder 2180 is coupled with the first mixer 2130 and the second mixer 2160, and an RF power amplifier 2190 is coupled with the adder 2180.

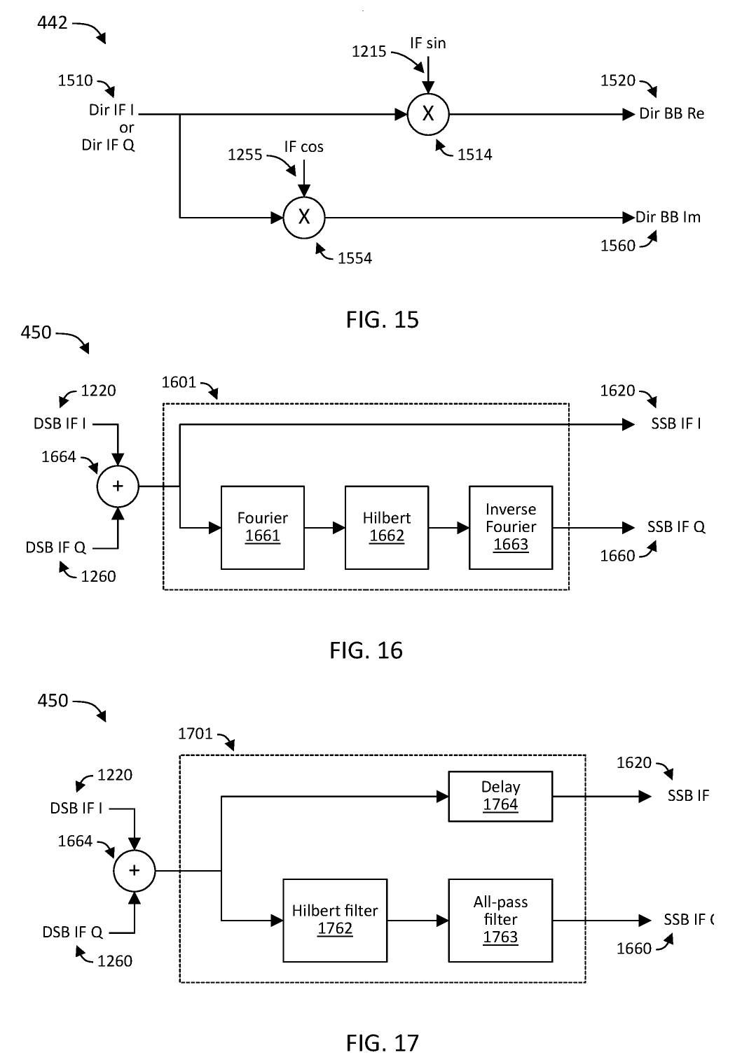

In some implementations, beamformer 460 and second-level demodulator 442 may be combined in an antenna channel module level circuit that includes the circuits in FIG. 20 and FIG. 15. Although FIG. 11 shows antenna channel modules 113 with the RF backend 470 depicted in FIG. 21, some implementations may use the RF backend 470 described with reference to FIG. 22.

Transmission can be made single sideband by including SSB prep unit 450 or RF filters 480 in or after the antenna channel modules.

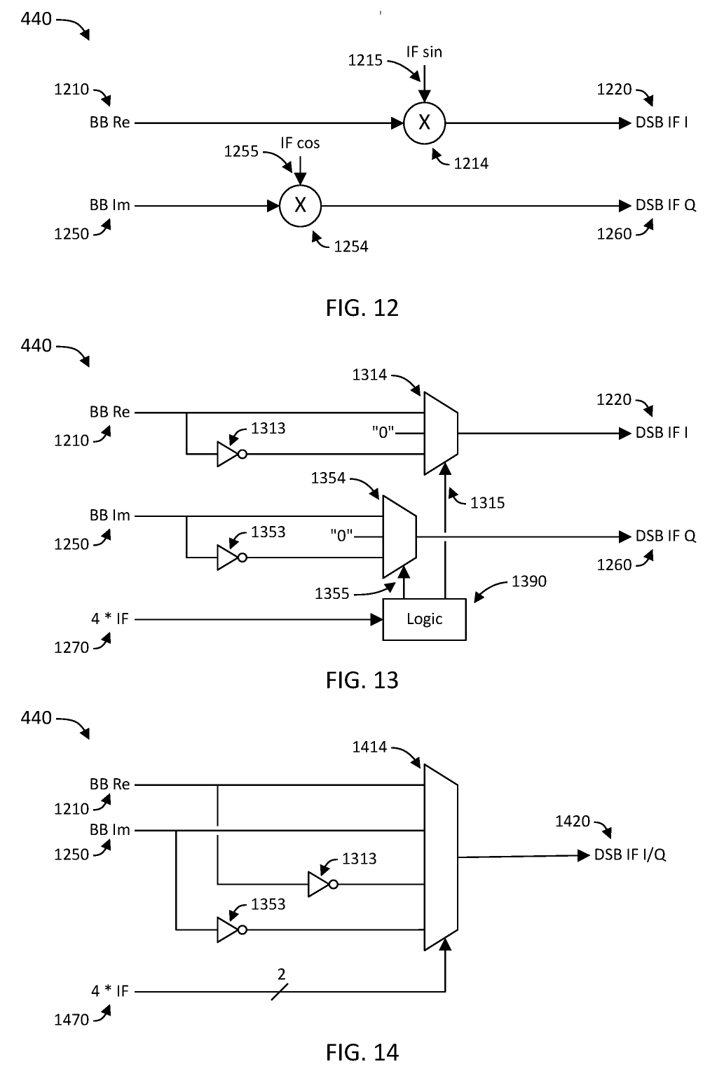

FIG. 12 illustrates an example implementation of second-level modulator 440. This second-level modulator provides DSB amplitude modulation for two independent input signals and produces two orthogonally modulated output signals. Second-level modulator 440 receives BB Re signal 1210 and BB Im signal 1250, as well as IF sine wave 1215 and IF cosine wave 1255. A multiplier 1214 multiplies BB Re signal 1210 with IF sine wave 1215, and multiplier 1254 multiplies BB Im signal 1250 with IF cosine wave 1255 to obtain DSB IF I signal 1220 and DSB IF Q signal 1260, respectively. Since IF sine wave 1215 and IF cosine wave 1255 have a phase difference of ninety degrees, they are orthogonal to each other, and even when DSB IF I signal 1220 and DSB IF Q signal 1260 are summed at some later stage, the input signals can be individually recovered (demodulated) by parallel multiplication of the summed signal with a sine wave that matches IF sine wave 1215 and a cosine wave that matches IF cosine wave 1255. Like the input signals, the output signals DSB IF I signal 1220 and DSB IF Q signal 1260 jointly represent a complex valued signal.

FIG. 13 illustrates another example implementation of second-level modulator 440. This implementation may be used when the local digital logic clock speed is an even number times the IF and DAC 2110 effectively samples at four times the IF, or DAC 2110 and DAC 2140 effectively sample at twice the IF. For example, at a clock speed of four times the IF, successive values in an IF sine wave are 0, 1, 0, and -1, whereas successive values in an IF cosine wave are 1, 0, -1, and 0. A binary number inverter 1313 generates the negative of the BB Re signal (multiplication with -1) and binary number inverter 1353 generates the negative of the BB Im signal (multiplication with -1). Binary number multiplexer 1314 selects among its input values BB Re, negative BB Re, and zero based on first select signal 1315, and binary number multiplexer 1354 selects among its input values BB Im, negative BB Im, and zero based on second select signal 1355. Logic circuit 1390, which may comprise a counter and/or combinational logic, derives first select signal 1315 and second select signal 1355 from its input which receives, for example, a clock signal 1270 at four times the intermediate frequency.

Since at a clock speed of four times the intermediate frequency the I and Q signals alternate (I equals 0 when Q is not 0, and Q equals 0 when I is not 0), an implementation may "add" the I and Q signals by combining binary number multiplexer 1314 and binary number multiplexer 1354 into a single multiplexer that has BB Re, minus BB Re, BB Im, and minus BB Im as its input signals. In some implementations, its single output signal may be directly applied to SSB prep unit 450 or DAC 2110, sampling at four times IF.

FIG. 14 illustrates yet another example implementation of second-level modulator 440. It adds the output signals to a combined in-phase and quadrature modulated DSB IF signal. This implementation may be used when the local digital logic clock speed is four times the IF. In this case, second-level modulator 440 receives BB Re signal 1210 and BB Im signal 1250 from orthogonal subcarrier generator 430 and generates their inverse values with binary number inverter 1313 and binary number inverter 1353. The four signals are provided to four-input first multiplier 1414 which cyclically, determined by select signal 1470, passes each of the four input signals to its DSB combined IF output signal 1420.

FIG. 15 illustrates an example second-level demodulator 442, for example as used in FIG. 11. In general, the circuit of FIG. 12 can achieve demodulation when a complex input signal is available and desired. However, in FIG. 11 second-level demodulator 442 receives a single input signal, which is either the directed IF I signal or the directed IF Q signal. Thus, the input signal is shared by both first multiplier 1514 and second multiplier 1554, which multiply the input signal with the IF sine wave and the IF cosine wave, respectively.

FIG. 16 illustrates an example implementation of SSB prep unit 450 based on Marple's method. This digital-domain circuit can take an orthogonal or nonorthogonal input signal and produce orthogonal output signals that can be used as quadrature inputs for beamforming and/or RF translation. Because of its digital nature and relative simplicity, it can remove a sideband even for very high-bandwidth signals. SSB prep unit 450 may receive DSB IF I signal 1220 and DSB IF Q signal 1260 and add these signals in adder 1664. The added signals enter Marple's unit 1401, which performs functionality ("Marple's method") as described in "Computing the discrete-time 'analytic' signal via FFT," by S.L. Marple Jr, IEEE Transactions on Signal Processing, Volume 47, September 1999, which is incorporated by reference herein, to remove the lower sideband (negative frequencies). Marple's unit 1401 outputs the added signals as SSB IF I signal 1620, but also performs a Hilbert transform on the added signals. The added signal enters a second path to remove the negative frequencies and scale the positive frequencies, generating the frequency spectrum of an orthogonal output signal, SSB IF Q signal 1660. This implementation performs the Hilbert transform in the frequency domain, utilizing, e.g., a Fourier transform 1661 or an FFT to obtain the complex frequency spectrum of SSB IF I signal 1620. Fourier transform 1661 transforms time-domain values from adder 1664 into frequency-domain values. Hilbert transform unit 1662 processes the frequency components as described by Marple. An inverse Fourier transform 1663 or IFFT transforms the remaining frequency-domain values back to time-domain values to obtain SSB IF Q signal 1660. Removing negative frequencies results in SSB IF Q signal 1660 which together with SSB IF I signal 1620 represents a complex valued signal.

Although in the above implementation Hilbert transform unit 1662 removes negative frequencies, other implementations may remove positive frequencies, resulting in filtering out the higher sideband instead of the lower sideband.

FIG. 17 illustrates another example implementation of SSB prep unit 450, based on a Hilbert filter 1762. The Hilbert filter can reduce or negate negative (or positive) frequencies and thus function as an SSB filter. In some implementations, the Hilbert filter is followed by an all-pass filter with phase response designed to compensate for any phase distortion that may occur in the Hilbert filter. A delay unit may compensate for delays in the Hilbert filter and the all-pass filter. In this implementation, SSB prep unit 450 includes SSB filter 1701 with Hilbert filter 1762 that operates in the time domain, unlike Hilbert transform unit 1662 which operates in the frequency domain. However, Hilbert filter 1762 may introduce some group delay or frequency-dependent phase errors. To compensate for phase errors, some implementations follow Hilbert filter 1762 by all-pass filter 1763. To compensate for delays in Hilbert filter 1762 and all-pass filter 1763 an implementation may include delay line 1764, which may be a first-in first-out (FIFO) memory that evens out the delay in the upper branch shown in FIG. 17.

Hilbert filters are well known in the art, see for example Carrick, Matt; Jaeger, Doug; and Harris, Fred (2011), "Design And Application Of A Hilbert Transformer In A Digital Receiver," Proceedings of the SDR 11 Technical Conference and Product Exposition, Wireless Innovation Forum, Chantilly, VA. Also, see https://en.wikipedia.org/wiki/Hilbert_transform (2025-03-14). Both are incorporated by reference as if set forth in full herein.

FIG. 18 illustrates an example of beamformer 460. Beamformer 460 receives a baseband real or IF in-phase signal 1820 and a baseband imaginary or IF quadrature signal 1860. It may pass baseband real or IF in-phase signal 1820 on to a first output as a first-channel directed baseband real or directed IF in-phase signal 1840-1, and baseband imaginary or IF quadrature signal 1860 as a first-channel directed baseband imaginary or directed IF quadrature signal 1870-1. As an example, the implementation may use these signals for a first sub-antenna in phased array antenna 116. Other sub-antennas may transmit signals that are appropriately delayed or phase rotated with respect to the first sub-antenna so that the resulting transmitted electromagnetic field is stronger in a desired direction than in other directions. For signals of a single frequency (in this case the IF frequency which is amplitude modulated by, for example, second-level modulator 440) delaying the signals may be achieved by phase rotating them. Thus, if transmitter 110 is used with a phased array antenna 116 that has M sub-antennas, signals for M-1 sub-antennas may need to be phase rotated versus each other and versus the first sub-antenna. Beamformer 460 thus includes M-1 phase rotators 461-2…M. Each of those receives baseband real or IF in-phase signal 1820 and baseband imaginary or IF quadrature signal 1860 and performs a phase rotation using directional information 1831.

FIG. 19 illustrates an example of phase rotator 461, that can be used as part of a beamformer 460 for a complex input signal, producing a complex output signal. The depicted circuit multiplies a complex input signal a + ib with complex scalar c + id, where i 2 = -1. If c equals the cosine of an angle θ and d equals the sine of the angleθ then the output signal is the input signal, unscaled, rotated over the angle θ. The circuit, along with other circuits, is well known in the art, and an implementation may use any such circuits.

Phase rotator 461 includes a first multiplier configured to receive a first IF I signal and first directional information 1930 including the sine of the rotation angle θ, a second multiplier configured to receive a first IF Q signal and the first directional information 1930, a third multiplier configured to receive the first IF I signal and second directional information 1932 including a cosine of the rotation angle θ, a fourth multiplier configured to receive the first IF Q signal and second directional information 1932, a subtractor configured to calculate a difference between outputs of the second multiplier and the third multiplier and to output the first directed IF I signal, and an adder configured to calculate a sum of values of outputs of the first multiplier and the fourth multiplier, and to output the first directed IF Q signal.

FIG. 20 illustrates another example of phase rotator 461 with a single output and based only on scaling the signal. This implementation may be used, for example, in beamformer 460 as used in FIG. 11.

FIG. 21 illustrates an example unit of RF backend 470 used to drive an antenna or a sub-antenna in phased array antenna 116. Each sub-antenna requires one unit of RF backend 470, which may be included in a antenna channel modules 113 along with other circuits. RF backend 470 receives directed IF I signal 1740 and directed IF Q signal 1770 which, if digital, DAC 2110 and DAC 2140 convert to analog signals. Two optional filters 2120 and 2150 coupled with DAC 2110 and DAC 2140 remove unwanted frequency components from the DAC output signals, and the resulting clean directed analog IF I and Q signals are provided to RF I mixer 2130 and RF Q mixer 2160, which may be a pair of analog multipliers that also receive an in-phase and quadrature (sine and cosine) version of an RF oscillator signal. The RF mixer signals of all units of RF backend 470 may come from a single central oscillator 2170 (as opposed to a local oscillator) to ensure that all sub-antennas receive RF signals that are phase aligned. The mixer output signals may be further filtered to remove unwanted frequency components (filter not shown) and are added in adder 2180 which creates a composite RF signal. An RF power amplifier 2190, which receives power 115 as well as the composite RF signal, amplifies the composite RF signal and forwards the amplified signal to the associated sub-antenna in phased array antenna 116. Some implementations include RF filter 480 before or after RF power amplifier 2190, for example to remove a sideband from a DSB signal. The example RF backend shown in FIG. 21 is basic, and many variations and improvements are known in the industry. All such variations and improvements are within the scope and the ambit of the disclosed technology.

While FIG. 1 showed that transmitter 110 receives both power information 114 and power 115, the power information 114 is used to specify power subcarriers 212. The implementation uses power 115 both for power subcarriers and other subcarriers. In some cases, the power to be transmitted in power subcarriers can be a substantial part of the total power.

FIG. 22 illustrates another example of RF backend 470 that uses a single DAC. DAC 2110 may be operated at four times the IF frequency used by the second-level modulator. If, as drawn, directed IF I signal 1740 and directed IF Q signal 1770 have not been "summed" previously, optional multiplexer 2210 alternatingly selects directed IF I signal 1740 and directed IF Q signal 1770. This action adds the two signals, since they're orthogonal. (Other implementations may use a digital adder instead of a multiplexer, but an adder is generally more complex and slower than a two-input multiplexer.) Optional filter 2120 removes unwanted frequency components from the DAC output signal and forwards the resulting clean directed analog IF signal to RF I mixer 2130 which also receives the RF oscillator signal. The RF mixer signals of all units of RF backend 470 may come from a single central oscillator 2170 (as opposed to a local oscillator) to help ensure phase alignment of the RF signals that sub-antennas receive. The mixer output signal creates a composite RF signal that may be further filtered to remove unwanted frequency components. RF power amplifier 2190, which receives power 115 as well as the composite RF signal, amplifies the composite RF signal and forwards the amplified signal to the associated sub-antenna in phased array antenna 116. Some implementations include RF filter 480 before or after RF power amplifier 2190, for example to remove a sideband from a DSB signal. The example RF backend shown in FIG. 22 is basic, and many variations and improvements are known in the industry. All such variations and improvements are within the scope and the ambit of the disclosed technology.

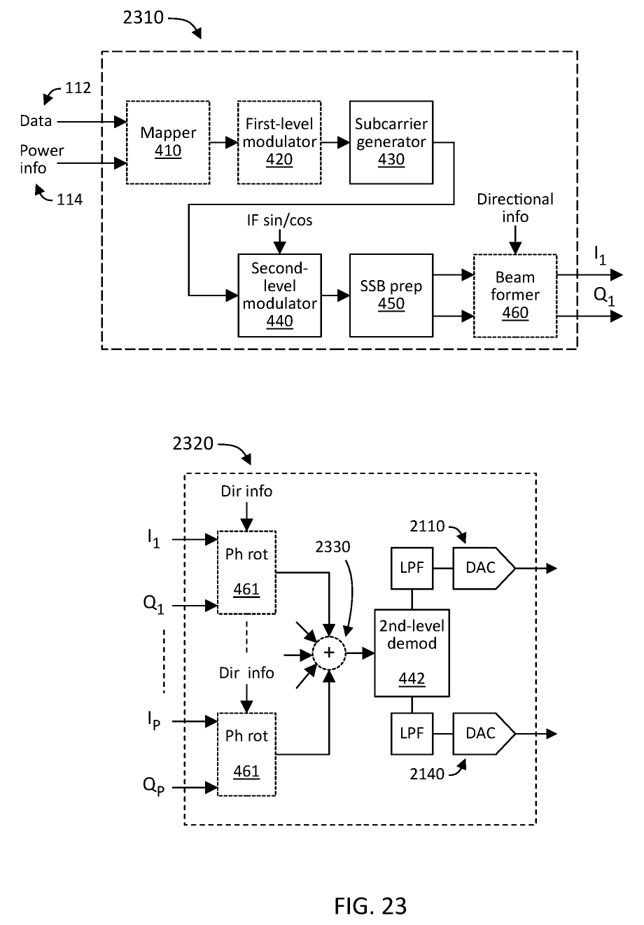

FIG. 23 illustrates an example baseband and IF integrated circuit 2310 and an example antenna channel integrated circuit 2320. Baseband and IF integrated circuit 2310 may include mapper 410 and first-level modulator 420 to generate subcarrier specifications based on data 112 and power information 114. It further includes orthogonal subcarrier generator 430, second-level modulator 440, and SSB prep unit 450. Thus, baseband and IF integrated circuit 2310 delivers an SSB IF signal that includes data 112 and power information 114. Optionally, it further includes beamformer 460 to deliver directed signals for further processing by multiple antenna channel modules 113.

Antenna channel integrated circuit 2320 is an integrated circuit that includes the digital portion of an antenna channel module 113. Antenna channel integrated circuit 2320 has one or more IF signal inputs, each IF signal input configured to receive an IF I signal and an IF Q signal. Antenna channel integrated circuit 2320 may include one or more phase rotators 461 and a combiner 2330. Phase rotator 461 is useful for systems that don't include a beamformer 460 in, for example, baseband and IF integrated circuit 2310. Each phase rotator 461 is coupled with one of the IF signal inputs. Multiple IF signal inputs are useful for systems according to the architecture of FIG. 6 or FIG. 7, replacing the units of beamformer 460, beamformer 660, and combiner 670. Antenna channel integrated circuit 2320 further includes second-level demodulator 442, DAC 2110, and optionally DAC 2140. Second-level demodulator 442 is configured to receive the combined output signal from the one or more phase rotators 461 (on combiner 2330) and to demodulate the combined output signal into a first directed baseband signal and a second directed baseband signal. DAC 2010 is coupled with an output of first second-level demodulator 442 and configured to convert the first directed baseband signal to a first analog signal.

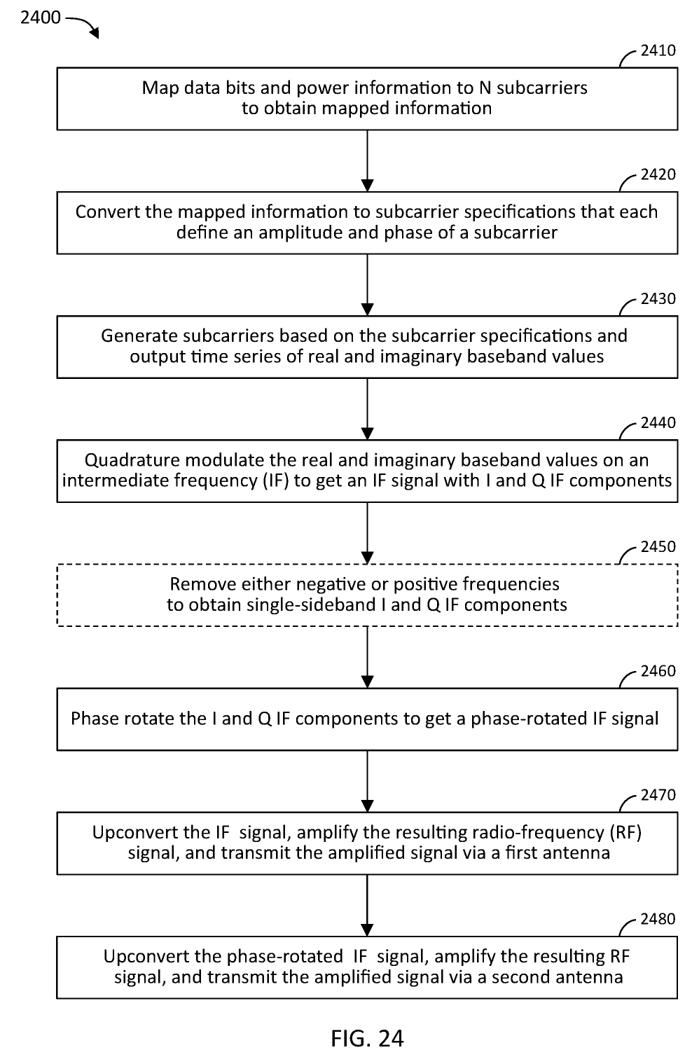

FIG. 24 illustrates an example method 2400 of transmitting data and power in one or more target directions. Method 2400 may use an architecture such as proposed by FIGS. 4 and 5. Method 2400 includes:

2410 – in a mapper (e.g., mapper 410), mapping data and power information to N subcarriers to obtain mapped information. N is an integer greater than 1.

2420 – in a first-level modulator (e.g., first-level modulator 420), converting the mapped information to subcarrier specifications. A subcarrier specification may comprise a complex number that defines the amplitude and phase of a subcarrier. The subcarrier specifications may be based on any modulation method (constellation), including BPSK, QPSK, M-ary PSK, QAM, PAM, etc.

2430 – in an orthogonal subcarrier generator (e.g., orthogonal subcarrier generator 430), generating the subcarriers based on the subcarrier specifications. Generating the subcarriers may include calculating and outputting a sum of the subcarriers as a time series of N successive values of a real baseband signal (the BB Re signal) and of an imaginary baseband signal (the BB Im signal). The orthogonal subcarrier generator may be or include or perform an inverse Fourier transform, an IDFT, an IFFT, or any other transform.

2440 – in a second-level modulator (e.g., second-level modulator 440), quadrature modulating on an intermediate frequency (IF) values included in the sum of the subcarriers to obtain an IF signal. This may include multiplying the BB Re signal with an in-phase IF sine wave and multiplying the BB Im signal with a quadrature IF cosine wave. The IF signal may include an IF I signal and an IF Q signal, respectively.

2450 – (optional) in a single-sideband prep unit (e.g., SSB prep unit 450), removing negative or positive frequencies to obtain SSB I and Q IF components. An implementation may perform Marple's method (as described with reference to FIG. 9) to remove positive or negative frequencies, or it may perform Hilbert filtering (as described with reference to FIG. 11) to reduce positive or negative frequencies.

2460 – phase rotating the IF I signal and the IF Q signal to obtain a phase rotated IF signal. An implementation may generate M-1 sets of phase rotated IF signals for use, together with the IF signal, in M sub-antennas in a phased array antenna.

2470 – in a first antenna channel module (e.g., an antenna channel module 113) upconverting the IF signal, amplifying the resulting first RF antenna signal, and transmitting it via a first antenna.

2480 – in a second antenna channel module (e.g., an antenna channel module 113), upconverting the phase-rotated IF signal, amplifying the resulting second RF antenna signal, and transmitting it via a second antenna.

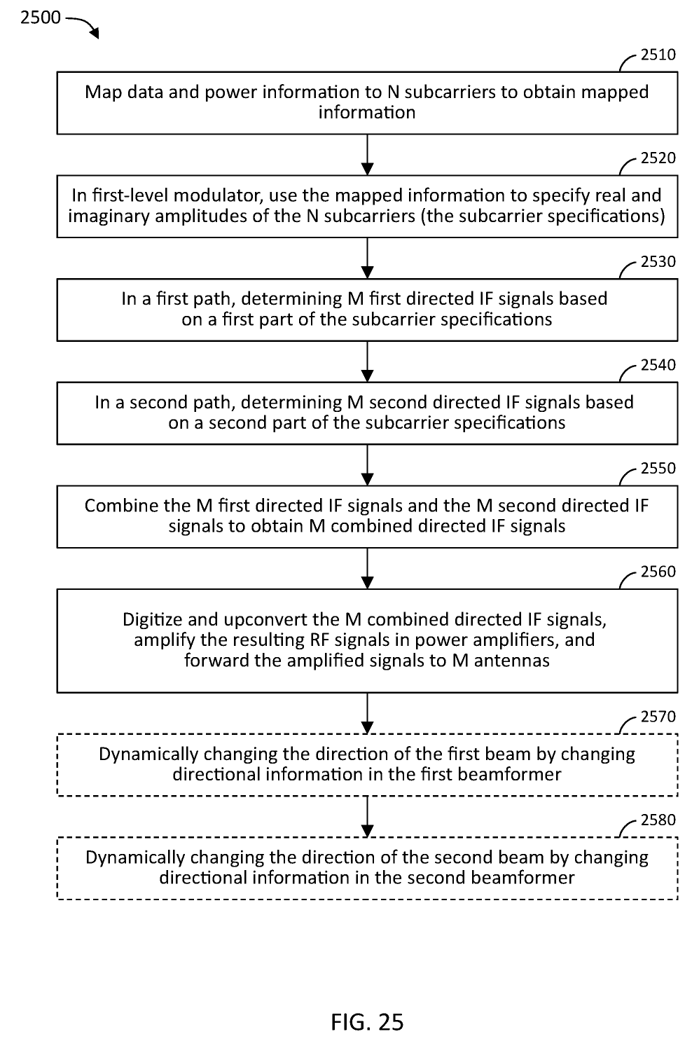

FIG. 25 illustrates an example method 2500 of transmitting data in a first direction and power in a second direction. More generally, method 2500 can be used to independently send data and/or power in multiple directions. Method 2500 uses an architecture such as proposed in FIG. 12. Method 2500 comprises:

2510 – in a mapper (e.g., mapper 410), mapping data and power information to N subcarriers to obtain mapped information. N is an integer greater than 1.

2520 – in a first-level modulator (e.g., first-level modulator 420), using the mapped information to determine subcarrier specifications. The subcarrier specifications may include real and imaginary amplitudes of the subcarriers. The subcarrier specifications may be based on any modulation method (constellation), including BPSK, QPSK, M-ary PSK, QAM, PAM, etc.

2530 – in a first path, receiving a first part of the subcarrier specifications and determining M first directed IF signals for M antennas, which may be M sub-antennas in a phased array antenna. The first path includes a first orthogonal subcarrier generator (e.g., orthogonal subcarrier generator 430), a first second-level modulator (e.g., second-level modulator 440), and a first beamformer (e.g., beamformer 460). M is an integer greater than 1, and the M first directed IF signals include phase and/or amplitude information to send data in the first direction. The first path may also include a first SSB prep unit, for example SSB prep unit 450. The implementation may determine the M first directed IF signals from the first part of the subcarrier specifications as described with reference to method 2400, operations 2430 through 2460.

2540 – in a second path, receiving a second part of the subcarrier specifications and determining M second directed IF signals for the M antennas. The second path includes a second orthogonal subcarrier generator (e.g., orthogonal subcarrier generator 1230), a second second-level modulator (e.g., second-level modulator 1240), and a second beamformer (e.g., beamformer 1260). The M second directed IF signals include phase and/or amplitude information to send data in the second direction. The second path may also include a second SSB prep unit, for example SSB prep unit 1250. The implementation may determine the M second directed IF signals from the second part of the subcarrier specifications as described with reference to method 2400, operations 2430 through 2460.

2550 – in M complex adders (e.g., combiner 670), combining the M first directed IF signals and the M second directed IF signals to obtain M combined directed IF signals.

2560 – upconverting the M combined directed IF signals to M radio-frequency signals (RF signals), amplifying the M RF signals in M RF power amplifiers, and transmitting resulting M amplified RF signals via M antennas.

The first path 610 may include a beamformer 460, and method 2500 may further include:

2570 – dynamically changing the direction of the first beam by changing directional information in beamformer 460. An implementation may obtain the directional information in various ways. For example, it may receive locational information from a target receiver in the form of global positioning system (GPS) coordinates, it may obtain directional information from a receiver in contact with the target receiver, it may otherwise measure the direction of the target receiver, it may read directional information of the target receiver from a memory, for example based on an ID of the target receiver, it may use radar information, or any other information at its avail.

Similarly, second path 620 may include a beamformer 660, and method 2500 may further include:

2580 – dynamically changing the direction of the second beam by changing directional information in beamformer 660. An implementation may obtain the directional information in various ways. For example, it may receive locational information from a target receiver in the form of global positioning system (GPS) coordinates, it may obtain directional information from a receiver in contact with the target receiver, it may otherwise measure the direction of the target receiver, it may read directional information of the target receiver from a memory, for example based on an ID of the target receiver, it may use radar information, or any other information at its avail.

In some cases, second path 720 includes a memory 710 and a beamformer 660. Generating M second directed IF signals based on a second part of the subcarrier specifications includes reading the M second directed IF signals from memory 710.

Some implementations may combine the first path and the second path, for example by time-multiplexing shared circuitry, for example including the orthogonal subcarrier generators, second-level modulators, beamformers, and optionally SSB Prep units.

### PARTICULAR IMPLEMENTATIONS

Described implementations of the subject matter can include one or more features, alone or in combination, as described in the following first set of clauses.

Clause 1. A transmitter 110, comprising:

a mapper 410 configured to map data bits 112 and power information 114 to N subcarriers to obtain mapped information, wherein N is an integer larger than 1;

a first-level modulator 420 coupled with an output of the mapper 410 and configured to receive at least a first part of the mapped information and convert the at least the first part of the mapped information into at least a first part of subcarrier specifications, wherein a subcarrier specification includes a complex number that defines an amplitude and a phase of a subcarrier;

a first orthogonal subcarrier generator 430 coupled with an output of the first-level modulator 420, configured to:

receive the at least the first part of the subcarrier specifications:

translate the at least the first part of the subcarrier specifications from a frequency domain to a time domain; and

generate a first baseband real signal (a first BB Re signal) and a first baseband imaginary signal (a first BB Im signal) that include at least a first part of the N subcarriers;

a first second-level modulator 440 coupled with an output of the first orthogonal subcarrier generator 430 and configured to receive the first BB Re signal and the first BB Im signal and to multiply the first BB Re signal with an in-phase intermediate-frequency sine wave (an IF sine wave) and to multiply the first BB Im signal with a quadrature intermediate-frequency cosine wave (an IF cosine wave) to obtain a first IF I signal and a first IF Q signal;

a first beamformer 460 coupled with an output of the first second-level modulator 440 and configured to receive the first IF I signal and the first IF Q signal and, for one or more antenna channels, to modify a phase and/or an amplitude of the first IF I signal and/or the first IF Q signal to obtain a first directed IF I signal and/or a first directed IF Q signal; and

two or more antenna channel modules 113, each configured to drive an antenna 116 and each including:

a first digital-to-analog converter (a first DAC 2110), coupled with an output of the first beamformer 460 and configured to convert at least one of the first directed IF I signal and the first directed IF Q signal to an analog signal.

Clause 2. The transmitter of clause 1, wherein the data bits 112 have a bandwidth of more than one hundred megabits per second (100 Mbps) and wherein the first IF I signal and the first IF Q signal occupy a spectrum of at least ten megahertz (10 MHz).

Clause 3. The transmitter of clause 1 or clause 2, wherein an antenna channel module 113 further comprises an oscillator 2170, a first mixer 2130 coupled with the first DAC 2110 and the oscillator 2170, a power amplifier 2190 coupled with the first mixer 2130 and an RF filter 480, and wherein the RF filter 480 is configured to reduce or remove a sideband from a double-sideband signal.

Clause 4. The transmitter of any of the clauses 1 to 3, wherein the first beamformer 460 comprises a phase rotator 461, including a first multiplier configured to receive the first IF I signal and first directional information including a sine of a rotation angle, a second multiplier configured to receive the first IF Q signal and the first directional information, a third multiplier configured to receive the first IF I signal and second directional information including a cosine of the rotation angle, a fourth multiplier configured to receive the first IF Q signal and the second directional information, a subtractor configured to calculate a difference between outputs of the second multiplier and the third multiplier and to output the first directed IF I signal, and an adder configured to calculate a sum of values of outputs of the first multiplier and the fourth multiplier, and to output the first directed IF Q signal.

Clause 5. The transmitter of any of the clauses 1 to 4, further comprising a first single-sideband prep unit (a first SSB prep unit 450) coupled between the first second-level modulator 440 and the first beamformer 460, and configured to reduce or remove either negative or positive frequency components from the first IF I signal and the first IF Q signal, and wherein the first SSB prep unit 450 includes:

a digital Fourier transform circuit (a DFT circuit 1661) configured to transform time-domain values in the first IF I signal and the first IF Q signal to frequency-domain values;

a Hilbert transform unit 1662 configured to negate part of the frequency-domain values related to either negative or positive frequencies; and

an SSB prep unit IDFT circuit 1663 configured to transform the frequency-domain values to time-domain values;

wherein the DFT circuit 1661, the Hilbert transform unit 1662 and the SSB prep unit IDFT circuit 1663 are configured to perform Marple's method and the first SSB prep unit 450 outputs both an in-phase IF signal and a quadrature IF signal.

Clause 6. The transmitter of any of the clauses 1 to 4, further comprising a first single-sideband prep unit (a first SSB prep unit 450) coupled between the first second-level modulator 440 and the first beamformer 460, and configured to reduce or remove either negative or positive frequency components from the first IF I signal and the first IF Q signal, and wherein the first SSB prep unit 450 includes a Hilbert filter 1762.

Clause 7. The transmitter of any of the clauses 5 to 6, wherein the first SSB prep unit 450 is implemented in an integrated circuit (IC) using at least one of dedicated logic or a digital signal processor (DSP).

Clause 8. The transmitter of any of the clauses 1 to 7, further comprising:

a second orthogonal subcarrier generator 630 coupled with the output of the first-level modulator 420 and configured to receive at least a second part of the subcarrier specifications, and configured to generate a second baseband real signal (a second BB Re signal) and a second baseband imaginary signal (a second BB Im signal) that include at least a second part of the N subcarriers;

a second second-level modulator 640 coupled with an output of the second orthogonal subcarrier generator 630 and configured to receive the second BB Re signal and the second BB Im signal and to multiply the second BB Re signal with the IF sine wave and to multiply the second BB Im signal with the IF cosine wave to obtain a second IF I signal and a second IF Q signal;

a second beamformer 660 coupled with an output of the second second-level modulator 640 and configured to receive the second IF I signal and the second IF Q signal and, for the one or more antenna channels, to modify a phase and/or an amplitude of the second IF I signal and/or the second IF Q signal to obtain a second directed IF I signal and/or a second directed IF Q signal; and

two or more adders 670 each coupled with an output of the first beamformer 460 and an output of the second beamformer 660, and each coupled with an input of one of the two or more antenna channel modules 113.

Clause 9. A transmitter 110, comprising:

a mapper 410 configured to map data bits 112 and power information 114 to N subcarriers to obtain mapped information, wherein N is an integer larger than 1;

a first-level modulator 420 coupled with an output of the mapper 410 and configured to receive at least a first part of the mapped information and convert the at least the first part of the mapped information into at least a first part of subcarrier specifications, wherein a subcarrier specification includes a complex number that defines an amplitude and a phase of a subcarrier;

a first orthogonal subcarrier generator 430 coupled with an output of the first-level modulator 420, configured to:

receive the at least the first part of the subcarrier specifications:

translate the at least the first part of the subcarrier specifications from a frequency domain to a time domain; and

generate a first baseband real signal (a first BB Re signal) and a first baseband imaginary signal (a first BB Im signal) that include at least a first part of the N subcarriers;

a first beamformer 460 coupled with an output of the first orthogonal subcarrier generator 430 and configured to receive the first BB Re signal and the first BB Im signal and, for one or more antenna channels, to modify a phase and/or an amplitude of the first BB Re signal and/or the first BB Im signal to obtain a first directed BB Re signal and/or a first directed BB Im signal; and

two or more antenna channel modules 113, each configured to drive an antenna 116 and each including:

a first second-level modulator 440 coupled with an output of the first beamformer 460 and configured to receive the first directed BB Re signal and the first directed BB Im signal and to multiply the first directed BB Re signal with an in-phase intermediate-frequency sine wave (an IF sine wave) and to multiply the first directed BB Im signal with a quadrature intermediate-frequency cosine wave (an IF cosine wave) to obtain a first IF I signal and a first IF Q signal; and

a first digital-to-analog convertor (a first DAC 2110), coupled with an output of the first second-level modulator 440 and configured to convert at least one of the first IF I signal or the first IF Q signal to an analog signal.

Clause 10. The transmitter of clause 9, wherein the data bits 112 have a bandwidth of more than one hundred megabits per second (100 Mbps) and wherein the first IF I signal and the first IF Q signal occupy a spectrum of at least ten megahertz (10 MHz).

Clause 11. The transmitter of clause 9 or clause 10, wherein the first beamformer 460 comprises a phase rotator, including a first multiplier configured to receive the first BB Re signal and first directional information including a sine of a rotation angle, a second multiplier configured to receive the first BB Im signal and the first directional information, a third multiplier configured to receive the first BB Re signal and second directional information including a cosine of the rotation angle, a fourth multiplier configured to receive the first BB Im signal and the second directional information, a subtractor configured to calculate a difference between outputs of the second multiplier and the third multiplier and to output the first directed BB Re signal, and an adder configured to calculate a sum of values of outputs of the first multiplier and the fourth multiplier, and to output the first directed BB Im signal.

Clause 12. The transmitter of any of the clauses 9 to 11, wherein an antenna channel module 113 further comprises an oscillator 2170, a first mixer 2130 coupled with the first DAC 2110 and the oscillator 2170, a power amplifier 2190 coupled with the first mixer 2130 and an RF filter 480, and wherein the RF filter 480 is configured to reduce or remove a sideband from a double-sideband signal.

Clause 13. The transmitter of any of the clauses 9 to 12, wherein an antenna channel module 113 further comprises a first single-sideband prep unit (a first SSB prep unit 450) coupled between the first second-level modulator 440 and the first DAC 2110, and configured to reduce or remove either negative or positive frequency components from the first IF I signal and the first IF Q signal, and wherein the first SSB prep unit 450 includes:

a discrete Fourier transform circuit (a DFT circuit 1661) configured to transform time-domain values in the first IF I signal and the first IF Q signal to frequency-domain values;

a Hilbert transform unit 1662 configured to negate part of the frequency-domain values related to either negative or positive frequencies; and

an SSB prep unit IDFT circuit 1663 configured to transform the frequency-domain values to time-domain values;

wherein the DFT circuit 1661, the Hilbert transform unit 1662 and the SSB prep unit IDFT circuit 1663 are configured to perform Marple's method and the first SSB prep unit 450 outputs both an in-phase IF signal and a quadrature IF signal.

Clause 14. The transmitter of any of the clauses 9 to 12, wherein an antenna channel module 113 further comprises a first single-sideband prep unit (a first SSB prep unit 450) coupled between the first second-level modulator 440 and the first DAC 2110, and configured to reduce or remove either negative or positive frequency components from the first IF I signal and the first IF Q signal, and wherein the first SSB prep unit 450 includes a Hilbert filter 1762.

Clause 15. The transmitter of any of the clauses 13 to 14, wherein the first SSB prep unit 450 is implemented in an integrated circuit (IC) using at least one of dedicated logic or a digital signal processor (DSP).

Clause 16. A direct-to-RF transmitter 110, comprising:

a mapper 410 configured to map data bits 112 and power information 114 to N subcarriers to obtain mapped information, wherein N is an integer larger than 1;

a first-level modulator 420 coupled with an output of the mapper 410 and configured to receive at least a first part of the mapped information and convert the at least the first part of the mapped information into at least a first part of subcarrier specifications, each subcarrier specification including a complex number that defines an amplitude and a phase of a subcarrier;

a first orthogonal subcarrier generator 430 coupled with an output of the first-level modulator 420 and configured to receive the at least the first part of the subcarrier specifications, and configured to generate a first baseband real signal (a first BB Re signal) and a first baseband imaginary signal (a first BB Im signal) that include at least a first part of the N subcarriers;

a first beamformer 460 coupled with an output of the first orthogonal subcarrier generator 430 and configured to receive the first BB Re signal and the first BB Im signal and, for one or more antenna channels, to modify a phase and/or an amplitude of the first BB Re signal and/or the first BB Im signal to obtain a first directed BB Re signal and/or a first directed BB Im signal; and

two or more antenna channel modules 113, each configured to drive an antenna 116 and each including:

a first DAC 2110 configured to receive the first directed BB Re signal, an oscillator 2170 producing an RF I signal and an RF Q signal, a first mixer 2130 coupled with the first DAC 2110 and the oscillator 2170, a second DAC 2140 configured to receive the first directed BB Im signal, a second mixer 2160 coupled with the second DAC 2140 and the oscillator 2170, an adder 2180 coupled with the first mixer 2130 and the second mixer 2160, and a power amplifier 2190 coupled with the adder 2180.

Clause 17. The direct-to-RF transmitter of clause 16, wherein the first beamformer 460 comprises a phase rotator, including a first multiplier configured to receive the first BB Re signal and first directional information including a sine of a rotation angle, a second multiplier configured to receive the first BB Im signal and the first directional information, a third multiplier configured to receive the first BB Re signal and second directional information including a cosine of the rotation angle, a fourth multiplier configured to receive the first BB Im signal and the second directional information, a subtractor configured to calculate a difference between outputs of the second multiplier and the third multiplier and to output the first directed BB Re signal, and an adder configured to calculate a sum of values of outputs of the first multiplier and the fourth multiplier, and to output the first directed BB Im signal.

Clause 18. A direct-to-RF transmitter 110, comprising:

a mapper 410 configured to map data bits 112 and power information 114 to N subcarriers to obtain mapped information, wherein N is an integer larger than 1;

a first-level modulator 420 coupled with an output of the mapper 410 and configured to receive at least a first part of the mapped information and convert the at least the first part of the mapped information into at least a first part of subcarrier specifications, each subcarrier specification including a complex number that defines an amplitude and a phase of a subcarrier;

a first orthogonal subcarrier generator 430 coupled with an output of the first-level modulator 420 and configured to receive the at least the first part of the subcarrier specifications, and configured to generate a first baseband real signal (a first BB Re signal) and a first baseband imaginary signal (a first BB Im signal) that include at least a first part of the N subcarriers;

a first second-level modulator 440 coupled with an output of the first orthogonal subcarrier generator 430 and configured to receive the first BB Re signal and the first BB Im signal and to multiply the first BB Re signal with an in-phase intermediate-frequency sine wave (an IF sine wave) and to multiply the first BB Im signal with a quadrature intermediate-frequency cosine wave (an IF cosine wave) to obtain a first IF I signal and a first IF Q signal;

a first beamformer 460 coupled with an output of the first second-level modulator 440 and configured to receive the first IF I signal and the first IF Q signal and, for one or more antenna channels, to modify a phase and/or an amplitude of the first IF I signal and/or the first IF Q signal to obtain a first directed IF I signal and/or a first directed IF Q signal; and

two or more antenna channel modules 113, each configured to drive an antenna 116 and each including:

a first second-level demodulator 442 with two inputs both coupled with a single output of the first beamformer 460 and configured to receive one of the first directed IF I signal and the first directed IF Q signal and to demodulate this into a first directed BB Re signal and a first directed BB Im signal;

a first DAC 2110 coupled with an output of the first second-level demodulator 442 and configured to convert the first directed BB Re signal to an analog Re signal;

a second DAC 2140 coupled with an output of the first second-level demodulator 442 and configured to convert the first directed BB Im signal to an analog Im signal; and

an oscillator 2170 coupled with the first DAC 2110 producing an RF I signal and an RF Q signal, a first mixer 2130 coupled with the first DAC 2110 and the oscillator 2170, a second mixer 2160 coupled with the second DAC 2040 and the oscillator 2170, an adder 2180 coupled with the first mixer 2130 and the second mixer 2160, and a power amplifier 2190 coupled with the adder 2180.

Clause 19. The direct-to-RF transmitter of clause 18, further comprising a first single-sideband prep unit (a first SSB prep unit 450) coupled between the first second-level modulator 440 and the first beamformer 460, and configured to remove either negative or positive frequency components from the first IF I signal and the first IF Q signal, and wherein the first SSB prep unit 450 includes:

a discrete Fourier transform circuit (a DFT circuit 1661) configured to transform time-domain values in the first IF I signal and the first IF Q signal to frequency-domain values;

a Hilbert transform unit 1662 configured to negate part of the frequency-domain values related to either negative or positive frequencies; and

an SSB prep unit IDFT circuit 1663 configured to transform the frequency-domain values to time-domain values;

wherein the DFT circuit 1561, the Hilbert transform unit 1662 and the SSB prep unit IDFT circuit 1663 are configured to perform Marple's method and the first SSB prep unit 450 outputs both an in-phase IF signal and a quadrature IF signal.

Clause 20. The direct-to-RF transmitter of clause 18, further comprising a first single-sideband prep unit (a first SSB prep unit 450) coupled between the first second-level modulator 440 and the first beamformer 460, and configured to remove either negative or positive frequency components from the first IF I signal and the first IF Q signal, and wherein the first SSB prep unit 450 includes a Hilbert filter 1762.

Clause 21. A method (2300) of simultaneously transmitting broadband data and wireless power in a transmitter 110 including an orthogonal subcarrier generator 430, the method comprising:

mapping data bits and power information to N subcarriers to obtain mapped information, wherein N is an integer larger than 1;

converting at least a first part of the mapped information to subcarrier specifications, each subcarrier specification including a complex number that defines an amplitude and a phase of a subcarrier;

in the orthogonal subcarrier generator 430, generating subcarriers according to the subcarrier specifications and outputting a sum of the subcarriers as a time series of real baseband values and a time series of imaginary baseband values;

quadrature modulating on an intermediate frequency (IF) values included in the sum of the subcarriers to obtain an IF signal;

phase rotating the IF signal to obtain a phase-rotated IF signal;

in a first antenna channel modules 113, converting the IF signal from digital to an analog IF signal, and upconverting the analog IF signal to a radio-frequency signal (an RF signal);

in an antenna channel modules 113, converting the phase-rotated IF signal from digital to a phase-rotated analog IF signal, and upconverting the phase-rotated analog IF signal to a phase-rotated RF signal; and

transmitting the RF signal via a first antenna and the phase-rotated RF signal via a second antenna.

Clause 22. The method of clause 21, further comprising: performing a digital Fourier transform, a Hilbert transform, and an inverse discrete Fourier transform to negate a part of frequency-domain values related to either negative or positive frequencies in at least one of the IF signal and the phase-rotated IF signal.

Clause 23. The method of clause 21, further comprising performing a Hilbert filtering operation to reduce or suppress frequency components in a sideband of the IF signal.

Clause 24. A method (2400) of simultaneously transmitting broadband data and wireless power in a transmitter 110 including a first path 610 and a second path (620, 720), the method comprising:

mapping data bits and power information to N subcarriers to obtain mapped information, wherein N is an integer larger than one (1);

converting at least a first part of the mapped information to subcarrier specifications, each subcarrier specification including a complex number that defines a real amplitude and an imaginary amplitude of a subcarrier;

in the first path 610, generating M first directed IF signals based on a first part of the subcarrier specifications, wherein M is an integer larger than one (1);

in the second path 620, generating M second directed IF signals based on a second part of the subcarrier specifications;

in M complex adders (combiner 670), combining the M first directed IF signals and the M second directed IF signals to obtain M combined directed IF signals; and

in M antenna channel modules 113, upconverting the M combined directed IF signals to M radio-frequency signals (M RF signals), amplifying the M RF signals in M RF power amplifiers 2190, and transmitting resulting M amplified RF signals via M antennas.

Clause 25. The method of clause 24, wherein the first path 610 includes a beamformer 460, and further comprising dynamically changing a first beam direction by changing directional information in the beamformer 460.

Clause 26. The method of clause 24 or clause 25, wherein the second path 620 includes a beamformer 660, and further comprising dynamically changing a second beam direction by changing directional information in the beamformer 660.

Clause 27. The method of any of the clauses 24 to 26, wherein the first path 610 comprises a first orthogonal subcarrier generator 430, a first first-level modulator 420, and a first beamformer 460.

Clause 28. The method of any of the clauses 24 to 27, wherein the first path 610 further comprises a first SSB prep unit 450 to remove either negative or positive frequency components from a first IF signal.

Clause 29. The method of any of the clauses 24 to 28, wherein the second path 620 comprises a second orthogonal subcarrier generator 630, a second second-level modulator 640, and a second beamformer 660.

Clause 30. The method of any of the clauses 24 to 29, wherein the second path 620 further comprises a second SSB prep unit 650 unit to remove either negative or positive frequency components from a second IF signal.

Clause 31. The method of any of the clauses 24 to 30, wherein the second path 720 comprises a memory 710 and a second beamformer 660, and generating M second directed IF signals based on a second part of the subcarrier specifications includes reading the M second directed IF signals from the memory 710.

Clause 32. The method of any of the clauses 24 to 31, wherein the first path 610 and the second path 620 use time-multiplexing on shared circuitry, the shared circuity including a first orthogonal subcarrier generator 430, a first second-level modulator 440, and a first beamformer 460.

Clause 33. An antenna channel integrated circuit (2220) comprising:

one or more IF signal inputs;

one or more phase rotators 461, each coupled with one of the one or more IF signal inputs;

a first second-level demodulator 442 configured to receive a combined output signal from the one or more phase rotators 461 and to demodulate the combined output signal into a first directed baseband signal and a second directed baseband signal; and

a first DAC 2010 coupled with an output of the first second-level demodulator 442 and configured to convert the first directed baseband signal to a first analog signal.

Described implementations of the subject matter can include one or more features, alone or in combination, as described in the following second set of clauses.

Clause 1. A transmitter 110, comprising:

a mapper 410 configured to map data bits 112 and power information 114 to N subcarriers to obtain mapped information, wherein N is an integer larger than 1;

a first-level modulator 420 coupled with an output of the mapper 410 and configured to receive at least a first part of the mapped information and convert the at least the first part of the mapped information into at least a first part of subcarrier specifications, wherein a subcarrier specification includes a complex number that defines an amplitude and a phase of a subcarrier;

a first orthogonal subcarrier generator 430 coupled with an output of the first-level modulator 420, configured to:

receive the at least the first part of the subcarrier specifications:

translate the at least the first part of the subcarrier specifications from a frequency domain to a time domain; and

generate a first baseband real signal (a first BB Re signal) and a first baseband imaginary signal (a first BB Im signal) that include at least a first part of the N subcarriers;

a first second-level modulator 440 coupled with an output of the first orthogonal subcarrier generator 430 and configured to receive the first BB Re signal and the first BB Im signal and to multiply the first BB Re signal with an in-phase intermediate-frequency sine wave (an IF sine wave) and to multiply the first BB Im signal with a quadrature intermediate-frequency cosine wave (an IF cosine wave) to obtain a first IF I signal and a first IF Q signal;

a first beamformer 460 coupled with an output of the first second-level modulator 440 and configured to receive the first IF I signal and the first IF Q signal and, for one or more antenna channels, to modify a phase and/or an amplitude of the first IF I signal and/or the first IF Q signal to obtain a first directed IF I signal and/or a first directed IF Q signal; and

two or more antenna channel modules 113, each configured to drive an antenna 116 and each including:

a first digital-to-analog converter (a first DAC 2110), coupled with an output of the first beamformer 460 and configured to convert at least one of the first directed IF I signal and the first directed IF Q signal to an analog signal.

Clause2. The transmitter of clause 1, wherein the first DAC 2110 is clocked at an even number times a frequency of the IF sine wave.

Clause 3. The transmitter of clause 1, wherein the data bits 112 have a bandwidth of more than six gigabits per second (6 Gbps) and wherein the first IF I signal and the first IF Q signal occupy a spectrum of at least two gigahertz (2 GHz).

Clause 4. The transmitter of clause 1, wherein the first orthogonal subcarrier generator 430 includes an inverse discrete Fourier transform (IDFT) circuit.

Clause 5. A transmitter 110, comprising:

a mapper 410 configured to map data bits 112 and power information 114 to N subcarriers to obtain mapped information, wherein N is an integer larger than 1;

a first-level modulator 420 coupled with an output of the mapper 410 and configured to receive at least a first part of the mapped information and convert the at least the first part of the mapped information into at least a first part of subcarrier specifications, wherein a subcarrier specification includes a complex number that defines an amplitude and a phase of a subcarrier;

a first orthogonal subcarrier generator 430 coupled with an output of the first-level modulator 420, configured to:

receive the at least the first part of the subcarrier specifications:

translate the at least the first part of the subcarrier specifications from a frequency domain to a time domain; and

generate a first baseband real signal (a first BB Re signal) and a first baseband imaginary signal (a first BB Im signal) that include at least a first part of the N subcarriers;

a first beamformer 460 coupled with an output of the first orthogonal subcarrier generator 430 and configured to receive the first BB Re signal and the first BB Im signal and, for one or more antenna channels, to modify a phase and/or an amplitude of the first BB Re signal and/or the first BB Im signal to obtain a first directed BB Re signal and/or a first directed BB Im signal; and

two or more antenna channel modules 113, each configured to drive an antenna 116 and each including:

a first second-level modulator 440 coupled with an output of the first beamformer 460 and configured to receive the first directed BB Re signal and the first directed BB Im signal and to multiply the first directed BB Re signal with an in-phase intermediate-frequency sine wave (an IF sine wave) and to multiply the first directed BB Im signal with a quadrature intermediate-frequency cosine wave (an IF cosine wave) to obtain a first IF I signal and a first IF Q signal; and

a first digital-to-analog convertor (a first DAC 2110), coupled with an output of the first second-level modulator 440 and configured to convert at least one of the first IF I signal or the first IF Q signal to an analog signal.

Clause 6. The transmitter of clause 5, wherein the first DAC 2110 is clocked at an even number times a frequency of the IF sine wave.

Clause 7. The transmitter of clause 5, wherein the data bits 112 have a bandwidth of more than six gigabits per second (6 Gbps) and wherein the first IF I signal and the first IF Q signal occupy a spectrum of at least two gigahertz (2 GHz).

Clause 8. The transmitter of clause 5, wherein the first orthogonal subcarrier generator 430 includes an inverse discrete Fourier transform (IDFT) circuit.

Clause 9. A method (2300) of simultaneously transmitting broadband data and wireless power in a transmitter 110 including an orthogonal subcarrier generator 430, the method comprising:

mapping data bits and power information to N subcarriers to obtain mapped information, wherein N is an integer larger than 1;

converting at least a first part of the mapped information to subcarrier specifications, each subcarrier specification including a complex number that defines an amplitude and a phase of a subcarrier;

in the orthogonal subcarrier generator 430, generating subcarriers according to the subcarrier specifications and outputting a sum of the subcarriers as a time series of real baseband values and a time series of imaginary baseband values;

quadrature modulating on an intermediate frequency (IF) values included in the sum of the subcarriers to obtain an IF signal;

phase rotating the IF signal to obtain a phase-rotated IF signal;

in a first antenna channel modules 113, converting the IF signal from digital to an analog IF signal, and upconverting the analog IF signal to a radio-frequency signal (an RF signal);

in an antenna channel modules 113, converting the phase-rotated IF signal from digital to a phase-rotated analog IF signal, and upconverting the phase-rotated analog IF signal to a phase-rotated RF signal; and

transmitting the RF signal via a first antenna and the phase-rotated RF signal via a second antenna.

Clause 10. The method of clause9, further comprising: performing a digital Fourier transform, a Hilbert transform, and an inverse discrete Fourier transform to negate a part of frequency-domain values related to either negative or positive frequencies in at least one of the IF signal and the phase-rotated IF signal.

Clause 11. The method of clause 9, further comprising performing a Hilbert filtering operation to reduce or suppress frequency components in a sideband of the IF signal.

Clause 12. A method (2400) of simultaneously transmitting broadband data and wireless power in a transmitter 110 including a first path 610 and a second path (620, 720), the method comprising:

mapping data bits and power information to N subcarriers to obtain mapped information, wherein N is an integer larger than one (1);

converting at least a first part of the mapped information to subcarrier specifications, each subcarrier specification including a complex number that defines a real amplitude and an imaginary amplitude of a subcarrier;

in the first path 610, generating M first directed IF signals based on a first part of the subcarrier specifications, wherein M is an integer larger than one (1);

in the second path 620, generating M second directed IF signals based on a second part of the subcarrier specifications;

in M complex adders (combiner 670), combining the M first directed IF signals and the M second directed IF signals to obtain M combined directed IF signals; and

in M antenna channel modules 113, upconverting the M combined directed IF signals to M radio-frequency signals (M RF signals), amplifying the M RF signals in M RF power amplifiers 2190, and transmitting resulting M amplified RF signals via M antennas.

Clause 13. The method of clause 12, wherein the first path 610 includes a beamformer 460, and further comprising dynamically changing a first beam direction by changing directional information in the beamformer 460.

Clause 14. The method of clause12, wherein the second path 620 includes a beamformer 660, and further comprising dynamically changing a second beam direction by changing directional information in the beamformer 660.

Clause 15. The method of clause 12, wherein the first path 610 comprises a first orthogonal subcarrier generator 430, a first first-level modulator 420, and a first beamformer 460.

Clause 16. The method of clause 12, wherein the first path 610 further comprises a first SSB prep unit 450 to remove either negative or positive frequency components from a first IF signal.

Clause 17. The method of clause 12, wherein the second path 620 comprises a second orthogonal subcarrier generator 630, a second second-level modulator 640, and a second beamformer 660.

Clause 18. The method of clause12, wherein the second path 620 further comprises a second SSB prep unit 650 unit to remove either negative or positive frequency components from a second IF signal.

Clause 19. The method of clause 12, wherein the second path 720 comprises a memory 710 and a second beamformer 660, and generating M second directed IF signals based on a second part of the subcarrier specifications includes reading the M second directed IF signals from the memory 710.

Clause 19. The method of clause 12, wherein the first path 610 and the second path 620 use time-multiplexing on shared circuitry, the shared circuity including a first orthogonal subcarrier generator 430, a first second-level modulator 440, and a first beamformer 460.

Clause 20. An antenna channel integrated circuit (2220) comprising:

one or more IF signal inputs;

one or more phase rotators 461, each coupled with one of the one or more IF signal inputs;

a first second-level demodulator 442 configured to receive a combined output signal from the one or more phase rotators 461 and to demodulate the combined output signal into a first directed baseband signal and a second directed baseband signal; and

a first DAC 2010 coupled with an output of the first second-level demodulator 442 and configured to convert the first directed baseband signal to a first analog signal.

### CONSIDERATIONS

We describe various implementations of systems and methods to transmit a combination of broadband data and harvestable power in one or more targeted directions.

The technology disclosed can be practiced as a system, apparatus, or method. One or more features of an implementation can be combined with a base implementation. Implementations that are not mutually exclusive are taught to be combinable. One or more features of an implementation can be combined with other implementations. This disclosure periodically reminds the user of these options. Omission from some implementations of recitations that repeat these options should not be taken as limiting the combinations taught in the preceding sections – these recitations are hereby incorporated forward by reference into each of the implementations described herein.

Although the description has been described with respect to specific implementations thereof, these specific implementations are merely illustrative, and not restrictive. The description may reference specific structural implementations and methods and does not intend to limit the technology to the specifically disclosed implementations and methods. The technology may be practiced using other features, elements, methods and implementations. Implementations are described to illustrate the present technology, not to limit its scope, which is defined by the claims. Those of ordinary skill in the art recognize a variety of equivalent variations on the description above. For example, many of the individual functions described are well known in the art, and many different and improved implementations of these functions exist that all fall within the ambit and scope of the disclosed technology. The functions can be implemented as analog circuits on an IC, module, or printed circuit board (PCB), mixed-signal circuits on an IC, module, or PCB, digital circuits on an IC, module, or PCB, configurations of a field-programmable gate array (FPGA), firmware for optimized digital signal processors (DSPs), or software for general-purpose processors. Implementations may be as a single chip, or as a multi-chip module (MCM) packaging multiple semiconductor dies in a single package. All such variations and modifications are to be considered within the ambit of the disclosed technology, the nature of which is to be determined from the foregoing description.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise.

Any suitable technology for manufacturing electronic devices can be used to implement the circuits of specific implementations, including CMOS, FinFET, GAAFET, BiCMOS, bipolar, JFET, MOS, NMOS, PMOS, HBT, MESFET, etc. Different semiconductor materials can be employed, such as silicon, germanium, SiGe, GaAs, InP, GaN, SiC, graphene, etc. Circuits may have single-ended or differential inputs, and single-ended or differential outputs. Terminals to circuits may function as inputs, outputs, both, or be in a high-impedance state, or they may function to receive supply power, a ground reference, a reference voltage, a reference current, or other. Although the physical processing of signals may be presented in a specific order, this order may be changed in different specific implementations. In some specific implementations, multiple elements, devices, or circuits shown as sequential in this specification can be operating in parallel.

It will also be appreciated that one or more of the elements depicted in the drawings/figures can also be implemented in a more separated or integrated manner, or even removed or rendered as inoperable in certain cases, as is useful in accordance with a particular application.

Thus, while specific implementations have been described herein, latitudes of modification, various changes, and substitutions are intended in the foregoing disclosures, and it will be appreciated that in some instances some features of specific implementations will be employed without a corresponding use of other features without departing from the scope and spirit as set forth. Therefore, many modifications may be made to adapt a particular situation or material to the essential scope and spirit.

1. A transmitter, comprising:
a mapper configured to map data bits and power information to N subcarriers to obtain mapped information, wherein N is an integer larger than 1;
a first-level modulator coupled with an output of the mapper and configured to receive at least a first part of the mapped information and convert the at least the first part of the mapped information into at least a first part of subcarrier specifications, wherein a subcarrier specification includes a complex number that defines an amplitude and a phase of a subcarrier;
a first orthogonal subcarrier generator coupled with an output of the first-level modulator, configured to:
receive the at least the first part of the subcarrier specifications:
translate the at least the first part of the subcarrier specifications from a frequency domain to a time domain; and
generate a first baseband real signal (a first BB Re signal) and a first baseband imaginary signal (a first BB Im signal) that include at least a first part of the N subcarriers;
a first second-level modulator coupled with an output of the first orthogonal subcarrier generator and configured to receive the first BB Re signal and the first BB Im signal and to multiply the first BB Re signal with an in-phase intermediate-frequency sine wave (an IF sine wave) and to multiply the first BB Im signal with a quadrature intermediate-frequency cosine wave (an IF cosine wave) to obtain a first IF I signal and a first IF Q signal;
a first beamformer coupled with an output of the first second-level modulator and configured to receive the first IF I signal and the first IF Q signal and, for one or more antenna channels, to modify a phase and/or an amplitude of the first IF I signal and/or the first IF Q signal to obtain a first directed IF I signal and/or a first directed IF Q signal; and
two or more antenna channel modules, each configured to drive an antenna and each including:
a first digital-to-analog converter (a first DAC), coupled with an output of the first beamformer and configured to convert at least one of the first directed IF I signal and the first directed IF Q signal to an analog signal.

2. The transmitter of claim 1, wherein the data bits have a bandwidth of more than one hundred megabits per second (100 Mbps) and wherein the first IF I signal and the first IF Q signal occupy a spectrum of at least ten megahertz (10 MHz).

3. The transmitter of claim 1, wherein an antenna channel module further comprises an oscillator, a first mixer coupled with the first DAC and the oscillator, a power amplifier coupled with the first mixer and an RF filter, and wherein the RF filter is configured to reduce or remove a sideband from a double-sideband signal.

4. The transmitter of claim 1, wherein the first beamformer comprises a phase rotator, including a first multiplier configured to receive the first IF I signal and first directional information including a sine of a rotation angle, a second multiplier configured to receive the first IF Q signal and the first directional information, a third multiplier configured to receive the first IF I signal and second directional information including a cosine of the rotation angle, a fourth multiplier configured to receive the first IF Q signal and the second directional information, a subtractor configured to calculate a difference between outputs of the second multiplier and the third multiplier and to output the first directed IF I signal, and an adder configured to calculate a sum of values of outputs of the first multiplier and the fourth multiplier, and to output the first directed IF Q signal.

5. The transmitter of claim 1, further comprising a first single-sideband prep unit (a first SSB prep unit) coupled between the first second-level modulator and the first beamformer, and configured to reduce or remove either negative or positive frequency components from the first IF I signal and the first IF Q signal, and wherein the first SSB prep unit includes:
a digital Fourier transform circuit (a DFT circuit) configured to transform time-domain values in the first IF I signal and the first IF Q signal to frequency-domain values;
a Hilbert transform unit configured to negate part of the frequency-domain values related to either negative or positive frequencies; and
an SSB prep unit IDFT circuit configured to transform the frequency-domain values to time-domain values;
wherein the DFT circuit, the Hilbert transform unit and the SSB prep unit IDFT circuit are configured to perform Marple's method and the first SSB prep unit outputs both an in-phase IF signal and a quadrature IF signal.

6. The transmitter of claim 1, further comprising a first single-sideband prep unit (a first SSB prep unit) coupled between the first second-level modulator and the first beamformer, and configured to reduce or remove either negative or positive frequency components from the first IF I signal and the first IF Q signal, and wherein the first SSB prep unit includes a Hilbert filter.

7. The transmitter of claim 1, further comprising a first single-sideband prep unit (a first SSB prep unit) coupled between the first second-level modulator and the first beamformer, and configured to reduce or remove either negative or positive frequency components from the first IF I signal and the first IF Q signal, and wherein the first SSB prep unit is implemented in an integrated circuit (IC) using at least one of dedicated logic or a digital signal processor (DSP).

8. The transmitter of claim 1, further comprising:
a second orthogonal subcarrier generator coupled with the output of the first-level modulator and configured to receive at least a second part of the subcarrier specifications, and configured to generate a second baseband real signal (a second BB Re signal) and a second baseband imaginary signal (a second BB Im signal) that include at least a second part of the N subcarriers;
a second second-level modulator coupled with an output of the second orthogonal subcarrier generator and configured to receive the second BB Re signal and the second BB Im signal and to multiply the second BB Re signal with the IF sine wave and to multiply the second BB Im signal with the IF cosine wave to obtain a second IF I signal and a second IF Q signal;
a second beamformer coupled with an output of the second second-level modulator and configured to receive the second IF I signal and the second IF Q signal and, for the one or more antenna channels, to modify a phase and/or an amplitude of the second IF I signal and/or the second IF Q signal to obtain a second directed IF I signal and/or a second directed IF Q signal; and
two or more adders each coupled with an output of the first beamformer and an output of the second beamformer, and each coupled with an input of one of the two or more antenna channel modules.

9. A transmitter, comprising:
a mapper configured to map data bits and power information to N subcarriers to obtain mapped information, wherein N is an integer larger than 1;
a first-level modulator coupled with an output of the mapper and configured to receive at least a first part of the mapped information and convert the at least the first part of the mapped information into at least a first part of subcarrier specifications, wherein a subcarrier specification includes a complex number that defines an amplitude and a phase of a subcarrier;
a first orthogonal subcarrier generator coupled with an output of the first-level modulator, configured to:
receive the at least the first part of the subcarrier specifications:
translate the at least the first part of the subcarrier specifications from a frequency domain to a time domain; and
generate a first baseband real signal (a first BB Re signal) and a first baseband imaginary signal (a first BB Im signal) that include at least a first part of the N subcarriers;
a first beamformer coupled with an output of the first orthogonal subcarrier generator and configured to receive the first BB Re signal and the first BB Im signal and, for one or more antenna channels, to modify a phase and/or an amplitude of the first BB Re signal and/or the first BB Im signal to obtain a first directed BB Re signal and/or a first directed BB Im signal; and
two or more antenna channel modules, each configured to drive an antenna and each including:
a first second-level modulator coupled with an output of the first beamformer and configured to receive the first directed BB Re signal and the first directed BB Im signal and to multiply the first directed BB Re signal with an in-phase intermediate-frequency sine wave (an IF sine wave) and to multiply the first directed BB Im signal with a quadrature intermediate-frequency cosine wave (an IF cosine wave) to obtain a first IF I signal and a first IF Q signal; and
a first digital-to-analog convertor (a first DAC), coupled with an output of the first second-level modulator and configured to convert at least one of the first IF I signal or the first IF Q signal to an analog signal.

10. The transmitter of claim 9, wherein the data bits have a bandwidth of more than one hundred megabits per second (100 Mbps) and wherein the first IF I signal and the first IF Q signal occupy a spectrum of at least ten megahertz (10 MHz).

11. The transmitter of claim 9, wherein the first beamformer comprises a phase rotator, including a first multiplier configured to receive the first BB Re signal and first directional information including a sine of a rotation angle, a second multiplier configured to receive the first BB Im signal and the first directional information, a third multiplier configured to receive the first BB Re signal and second directional information including a cosine of the rotation angle, a fourth multiplier configured to receive the first BB Im signal and the second directional information, a subtractor configured to calculate a difference between outputs of the second multiplier and the third multiplier and to output the first directed BB Re signal, and an adder configured to calculate a sum of values of outputs of the first multiplier and the fourth multiplier, and to output the first directed BB Im signal.

12. The transmitter of claim 9, wherein an antenna channel module further comprises an oscillator, a first mixer coupled with the first DAC and the oscillator, a power amplifier coupled with the first mixer and an RF filter, and wherein the RF filter is configured to reduce or remove a sideband from a double-sideband signal.

13. The transmitter of claim 9, wherein an antenna channel module further comprises a first single-sideband prep unit (a first SSB prep unit) coupled between the first second-level modulator and the first DAC, and configured to reduce or remove either negative or positive frequency components from the first IF I signal and the first IF Q signal, and wherein the first SSB prep unit includes:
a discrete Fourier transform circuit (a DFT circuit) configured to transform time-domain values in the first IF I signal and the first IF Q signal to frequency-domain values;
a Hilbert transform unit configured to negate part of the frequency-domain values related to either negative or positive frequencies; and
an SSB prep unit IDFT circuit configured to transform the frequency-domain values to time-domain values;
wherein the DFT circuit, the Hilbert transform unit and the SSB prep unit IDFT circuit are configured to perform Marple's method and the first SSB prep unit outputs both an in-phase IF signal and a quadrature IF signal.

14. The transmitter of claim 9, wherein an antenna channel module further comprises a first single-sideband prep unit (a first SSB prep unit) coupled between the first second-level modulator and the first DAC, and configured to reduce or remove either negative or positive frequency components from the first IF I signal and the first IF Q signal, and wherein the first SSB prep unit includes a Hilbert filter.

15. The transmitter of claim 9, wherein an antenna channel module further comprises a first single-sideband prep unit (a first SSB prep unit) coupled between the first second-level modulator and the first DAC, and configured to reduce or remove either negative or positive frequency components from the first IF I signal and the first IF Q signal, and wherein the first SSB prep unit is implemented in an integrated circuit (IC) using at least one of dedicated logic or a digital signal processor (DSP).

16. A direct-to-RF transmitter, comprising:
a mapper configured to map data bits and power information to N subcarriers to obtain mapped information, wherein N is an integer larger than 1;
a first-level modulator coupled with an output of the mapper and configured to receive at least a first part of the mapped information and convert the at least the first part of the mapped information into at least a first part of subcarrier specifications, each subcarrier specification including a complex number that defines an amplitude and a phase of a subcarrier;
a first orthogonal subcarrier generator coupled with an output of the first-level modulator and configured to receive the at least the first part of the subcarrier specifications, and configured to generate a first baseband real signal (a first BB Re signal) and a first baseband imaginary signal (a first BB Im signal) that include at least a first part of the N subcarriers;
a first beamformer coupled with an output of the first orthogonal subcarrier generator and configured to receive the first BB Re signal and the first BB Im signal and, for one or more antenna channels, to modify a phase and/or an amplitude of the first BB Re signal and/or the first BB Im signal to obtain a first directed BB Re signal and/or a first directed BB Im signal; and
two or more antenna channel modules, each configured to drive an antenna and each including:
a first DAC configured to receive the first directed BB Re signal, an oscillator producing an RF I signal and an RF Q signal, a first mixer coupled with the first DAC and the oscillator, a second DAC configured to receive the first directed BB Im signal, a second mixer coupled with the second DAC and the oscillator, an adder coupled with the first mixer and the second mixer, and a power amplifier coupled with the adder.

17. The direct-to-RF transmitter of claim 16, wherein the first beamformer comprises a phase rotator, including a first multiplier configured to receive the first BB Re signal and first directional information including a sine of a rotation angle, a second multiplier configured to receive the first BB Im signal and the first directional information, a third multiplier configured to receive the first BB Re signal and second directional information including a cosine of the rotation angle, a fourth multiplier configured to receive the first BB Im signal and the second directional information, a subtractor configured to calculate a difference between outputs of the second multiplier and the third multiplier and to output the first directed BB Re signal, and an adder configured to calculate a sum of values of outputs of the first multiplier and the fourth multiplier, and to output the first directed BB Im signal.

18. A direct-to-RF transmitter, comprising:
a mapper configured to map data bits and power information to N subcarriers to obtain mapped information, wherein N is an integer larger than 1;
a first-level modulator coupled with an output of the mapper and configured to receive at least a first part of the mapped information and convert the at least the first part of the mapped information into at least a first part of subcarrier specifications, each subcarrier specification including a complex number that defines an amplitude and a phase of a subcarrier;
a first orthogonal subcarrier generator coupled with an output of the first-level modulator and configured to receive the at least the first part of the subcarrier specifications, and configured to generate a first baseband real signal (a first BB Re signal) and a first baseband imaginary signal (a first BB Im signal) that include at least a first part of the N subcarriers;
a first second-level modulator coupled with an output of the first orthogonal subcarrier generator and configured to receive the first BB Re signal and the first BB Im signal and to multiply the first BB Re signal with an in-phase intermediate-frequency sine wave (an IF sine wave) and to multiply the first BB Im signal with a quadrature intermediate-frequency cosine wave (an IF cosine wave) to obtain a first IF I signal and a first IF Q signal;
a first beamformer coupled with an output of the first second-level modulator and configured to receive the first IF I signal and the first IF Q signal and, for one or more antenna channels, to modify a phase and/or an amplitude of the first IF I signal and/or the first IF Q signal to obtain a first directed IF I signal and/or a first directed IF Q signal; and
two or more antenna channel modules, each configured to drive an antenna and each including:
a first second-level demodulator with two inputs both coupled with a single output of the first beamformer and configured to receive one of the first directed IF I signal and the first directed IF Q signal and to demodulate this into a first directed BB Re signal and a first directed BB Im signal;
a first DAC coupled with an output of the first second-level demodulator and configured to convert the first directed BB Re signal to an analog Re signal;
a second DAC coupled with an output of the first second-level demodulator and configured to convert the first directed BB Im signal to an analog Im signal; and
an oscillator coupled with the first DAC producing an RF I signal and an RF Q signal, a first mixer coupled with the first DAC and the oscillator, a second mixer coupled with the second DAC and the oscillator, an adder coupled with the first mixer and the second mixer, and a power amplifier coupled with the adder.

19. The direct-to-RF transmitter of claim 18, further comprising a first single-sideband prep unit (a first SSB prep unit) coupled between the first second-level modulator and the first beamformer, and configured to remove either negative or positive frequency components from the first IF I signal and the first IF Q signal, and wherein the first SSB prep unit includes:
a discrete Fourier transform circuit (a DFT circuit) configured to transform time-domain values in the first IF I signal and the first IF Q signal to frequency-domain values;
a Hilbert transform unit configured to negate part of the frequency-domain values related to either negative or positive frequencies; and
an SSB prep unit IDFT circuit configured to transform the frequency-domain values to time-domain values;
wherein the DFT circuit, the Hilbert transform unit and the SSB prep unit IDFT circuit are configured to perform Marple's method and the first SSB prep unit outputs both an in-phase IF signal and a quadrature IF signal.

20. The direct-to-RF transmitter of claim 18, further comprising a first single-sideband prep unit (a first SSB prep unit) coupled between the first second-level modulator and the first beamformer, and configured to remove either negative or positive frequency components from the first IF I signal and the first IF Q signal, and wherein the first SSB prep unit includes a Hilbert filter.
